(19) United States
(12) Patent Application Publication
(10) Pub. No.: US 2006/0193330 A1
(43) Pub. Date: Aug. 31, 2006

(54) Communication apparatus, router apparatus, communication method and computer program product

(75) Inventors: Takeshi Ishihara, Kanagawa (JP); Naoki Esaka, Kanagawa (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/322,584

(22) Filed: Jan. 3, 2006

(30) Foreign Application Priority Data
Feb. 28, 2005 (JP) 2005-54755

(51) Int. Cl. H04L 12/28; H04L 12/56

(52) U.S. Cl. 370/395.53

(57) ABSTRACT

A communication apparatus includes a Virtual Private Network protocol dependent processing unit that processes a protocol related to a Virtual Private Network and acquires an identification information message related to determination of Virtual Private Network identification information being network identification information for use in communication by the Virtual Private Network from a message received from a communication apparatus of the other party of connection connected to a network; an identification information processing unit that determines the Virtual Private Network identification information by sending and receiving the identification information message to and from the communication apparatus of the other party of connection; and an advertisement processing unit that performs processing related to distribution of the Virtual Private Network identification information determined by the identification information processing unit into the network.

### CROSS-REFERENCE TO RELATED APPLICATIONS

This application is based upon and claims the benefit of priority from the prior Japanese Patent Application No. 2005-054755, filed on Feb. 28, 2005; the entire contents of which are incorporated herein by reference.

### BACKGROUND OF THE INVENTION

1. Field of the Invention

The present invention relates to a communication apparatus, a router apparatus, a communication method, and computer program product for establishing communication processing by VPN (Virtual Private Network) with a communication apparatus of the other party of connection connected to a network.

2. Description of the Related Art

VPN techniques, i.e. techniques in which communication by a network such as the Internet or a public line is made to virtually look like communication by a network built by a private line, can be broadly classified, based on their technical bases, into Layer 3VPN achieved using a technique of a network layer which is the third layer of the OSI basic reference protocol and Layer 2VPN achieved using a technique of a data link layer which is the second layer.

For Layer 3VPN, end nodes within a network are connected by the network layer, and therefore an IPv4 address and an IPv6 address which are network identification information of the third layer should be appropriately set among networks. For connection by Layer 2VPN, end nodes within a network are connected by the data link layer, and therefore network identification information such as an address and the like for use in communication is not required to be determined before VPN is established, but it can be determined after VPN connection.

On the other hand, VPN techniques are classified into the site-to-site VPN (also called inter-site connection VPN or inter-LAN connection VPN) and the remote access VPN according to a connection form. The site-to-site VPN is in the form of connecting a plurality of existing LANs (Local Area Network), and the remote access VPN is in the form of establishing connection to a computer on a remote site through, for example, a public line such as a general telephone line or ISDN line and connecting a remote node and a network such that a resource of the computer or a resource permitted through authentication there can be used.

The site-to-site VPN is widely used for both systems of Layer 2VPN and Layer 3VPN, but is based on the premise that it is operated in a state in which an appropriate setting is made under management by a network manager. Thus, mismatching of network related information in which network identification information such as an address under an IPv4 environment or a network prefix under an IPv6 environment is started among networks connected by the VPN protocol is solved by a network designer at a design stage.

For the remote access VPN, both Layer 2VPN and Layer 3 are widely used. If Layer 2VPN is used, a VPN server which is on the accessed side dynamically adds network related information to a VPN client which is on the accessing side as a general rule. For Layer 3VPN, VPN is established using network related information which is used in a network from which an access is made.

However, in any VPN, for virtually behaving as if connection to the network on the accessed side were established, it is necessary to use an address or address space previously agreed upon among networks to be connected, or to dynamically assign an address already used in a network to which a network in the accessed side such as, for example, the VPN server is connected, or assign a previously secured address, for an address for use in communication by VPN to which connection is established.

For example, Japanese Patent Laid-Open No. 2004-80703 discloses a technique in which a private address in the IPv4 address format of a network to which a network on the VPN server side is connected is assigned to the VPN client at the time when VPN connection is established. If an address is assigned in this way, an advantage of VPN that the VPN client can be connected transparently to a network on the accessing side can be made use of, but for determining whether a packet goes by way of VPN, all addresses having the potential of being assigned to the VPN client should be known, or processing of inquiring of the VPN server about an address is required.

Japanese Patent Laid-Open No. 2003-273897 discloses a technique in which a common address is assigned to a specific node group using E-mail and this common address is used to limit the access.

Further, in “Providing Network Services with Multiple Prefix Delegation,”Shinsuke SUZUKI, Hitachi, SAINT2004 is proposed an operation form in which a network prefix in the IPv6 format is assigned for each network application in the IPv6 network. Use of such address assignment makes it possible to clearly identify a group having a specific purpose.

However, the above-mentioned conventional technique is based on the premise that a manager preliminarily sets network identification information to ensure matching, and therefore there is the possibility that the technique is not appropriately operate in a network where no manager is present, such as, for example, a domestic network.

If Layer 2VPN is used, a plurality of separate Layer 2 segments which are not physically directly connected can be treated as one layer 2 segment, thus making it possible to use a network to which a VPN apparatus itself is connected and a remote network without discrimination.

Namely, if the VPN apparatus connects a network to which it is connected to another network, a broadcast packet or the like sent at the other segment passes through both networks connected by the VPN protocol.

When connection is established by Layer 2VPN between networks which are independent during a normal operation, such as domestic networks, packets carrying network setting information such as DHPC (Dynamic Host Configuration Protocol) and RA (Router Advertisement) exist between networks, and therefore there is the possibility that it is so difficult to limit the access that unauthorized packet forward occurs.

For example, if the broadcast packet is a packet for searching a DHCP server, a remote DHCP server can be searched as long as it is within a network connected by VPN.

In the case of a network using IPv6 for the network layer, end nodes within the network use stateless address automatic setting based on a router advertisement in the IPv6 format, and therefore there is the possibility that the IPv6 address of the remote network is automatically set based on a router advertisement passing from a remote network. If address-based access limitations are made under such a situation, there is the possibility that appropriate limitations cannot be applied.

### SUMMARY OF THE INVENTION

According to one aspect of the present invention, a communication apparatus includes a Virtual Private Network protocol dependent processing unit that processes a protocol related to a Virtual Private Network and acquires an identification information message related to determination of Virtual Private Network identification information being network identification information for use in communication by the Virtual Private Network from a message received from a communication apparatus of the other party of connection connected to a network; an identification information processing unit that determines the Virtual Private Network identification information by sending and receiving the identification information message to and from the communication apparatus of the other party of connection; and an advertisement processing unit that performs processing related to distribution of the Virtual Private Network identification information determined by the identification information processing unit into the network.

According to another aspect of the present invention, a router apparatus distributes network identification information into a network with a router advertisement when receiving a request for distribution of Virtual Private Network identification information being the network identification information for use in communication by a Virtual Private Network from a communication apparatus connected to a network.

According to still another aspect of the present invention, a communication method includes acquiring an identification information message related to determination of Virtual Private Network identification information being network identification information for use in communication by a Virtual Private Network from a message received from a communication apparatus of the other party of connection connected to a network while processing a protocol related to the Virtual Private Network; determining the Virtual Private Network identification information by sending and receiving the identification information message to and from the communication apparatus of the other party of connection; and performing processing related to distribution of the Virtual Private Network identification information determined by the identification information processing unit into the network.

According to still another aspect of the present invention, a communication method includes receiving a request for distribution of Virtual Private Network identification information being the network identification information for use in communication by a Virtual Private Network from a communication apparatus connected to a network; and distributing network identification information into a network with a router advertisement.

According to still another aspect of the present invention, a computer program product has a computer readable medium including programmed instructions for performing a communication processing. The instructions, when executed by a computer, cause the computer to perform acquiring an identification information message related to determination of Virtual Private Network identification information being network identification information for use in communication by a Virtual Private Network from a message received from a communication apparatus of the other party of connection connected to a network while processing a protocol related to the Virtual Private Network; determining the Virtual Private Network identification information by sending and receiving the identification information message to and from the communication apparatus of the other party of connection; and performing processing related to distribution of the Virtual Private Network identification information determined by the identification information processing unit into the network.

According to still another aspect of the present invention, a computer program product has a computer readable medium including programmed instructions for performing a communication processing. The instructions, when executed by a computer, cause the computer to perform receiving a request for distribution of Virtual Private Network identification information being the network identification information for use in communication by a Virtual Private Network from a communication apparatus connected to a network; and distributing network identification information into a network with a router advertisement.

### BRIEF DESCRIPTION OF THE DRAWINGS

FIG. 1 is an explanatory view showing a network configuration of a network system according to a first embodiment;

FIG. 2 is a block diagram showing a functional configuration of a VPN apparatus;

FIG. 3 is a data structure diagram showing a structure of VPN policy information;

FIG. 4 is an explanatory view showing one example of a structure of VPN connection information;

FIG. 5 is an explanatory view showing one example of a structure of network prefix information;

FIG. 6A is a flowchart showing a procedure of total processing of prefix determination by the VPN apparatus according to the first embodiment;

FIG. 6B is a flowchart showing a procedure of total processing of prefix determination by the VPN apparatus according to the first embodiment;

FIG. 7 is a sequence diagram showing an exchange of a message sent and received in prefix determination processing between two VPN apparatuses having a router function according to the first embodiment;

FIG. 8 is a sequence diagram showing an exchange of a message sent and received in prefix determination processing between the other two VPN apparatuses having no router function according to the first embodiment;

FIG. 9 is a flowchart showing a procedure of superiority or inferiority determination processing by a prefix processing unit;

FIG. 10 is a flowchart showing a procedure of prefix acquirement method determination processing;

FIG. 11 is a flowchart showing a procedure of prefix distribution method determination processing;

FIG. 12 is a flowchart showing a procedure of prefix distribution form determination processing;

FIG. 13 is a flowchart showing a procedure of prefix acquirement processing (local pool);

FIG. 14 is a flowchart showing a procedure of prefix acquirement processing (ISP);

FIG. 15 is a sequence diagram showing an exchange of a message sent and received between VPN apparatuses having a router function according to the first embodiment in prefix determination processing where a prefix acquirement method is ISP;

FIG. 16 is a flowchart showing a procedure of prefix acquirement processing (IPv6 ULA);

FIG. 17 is a flowchart showing a procedure of prefix acquirement processing (random);

FIG. 18 is a flowchart showing a procedure of packet filter setting change processing performed at the time of establishment of VPN connection;

FIG. 19 is a flowchart showing a procedure of packet filter setting change processing performed at the time of disconnection of VPN connection;

FIG. 20 is a flowchart showing a procedure of prefix distribution processing;

FIG. 21 is a flowchart showing a procedure of prefix distribution processing by a router apparatus;

FIG. 22 is an explanatory view showing packet filtering and the state of sending of an RA where it is determined that a prefix distribution method is “RA notification” and a prefix distribution form is “individual”;

FIG. 23 is an explanatory view showing packet filtering and the state,of sending of an RA message where “RA notification” and “RA request” exist for the prefix distribution method, and the prefix distribution form is determined to be “individual”;

FIG. 24 is an explanatory view showing packet filtering and the state of sending of an RA message where it is determined that the prefix distribution method is “RA notification” and the prefix distribution form is “collective”;

FIG. 25 is an explanatory view showing packet filtering and the state of sending of an RA message where it is determined that the prefix distribution method is “RA request” and the prefix distribution form is “collective”;

FIG. 26 is an explanatory view showing an example in which two VPN prefixes are determined between VPN apparatuses and distributed;

FIG. 27 is a block diagram showing a functional configuration of a VPN apparatus;

FIG. 28 is a sequence diagram showing an exchange of a message sent and received in prefix determination processing between VPN apparatuses having a router function in a first modification of a second embodiment;

FIG. 29 is a flowchart showing a procedure of prefix acquirement processing (local pool) by a VPN apparatus of the second embodiment;

FIG. 30 is a sequence diagram showing an exchange of a message in prefix determination processing between two VPN apparatuses having no router function according to a third embodiment;

FIG. 31 is a flowchart showing a procedure from determination of superiority or inferiority to prefix distribution processing in total processing of prefix determination by the VPN apparatus according to the third embodiment;

FIG. 32 is a sequence diagram showing an exchange of a message sent and received in prefix determination processing between two VPN apparatuses having no router function according to a fourth embodiment;

FIG. 33A is a flowchart showing a procedure of total processing of prefix determination by the VPN apparatus according to the fourth embodiment; and

FIG. 33B is a flowchart showing a procedure of total processing of prefix determination by the VPN apparatus according to the fourth embodiment.

### DETAILED DESCRIPTION OF THE INVENTION

Exemplary embodiments of a communication apparatus, a router apparatus, a communication method and a communication program according to the present invention will be described in detail below with reference to the attached drawings.

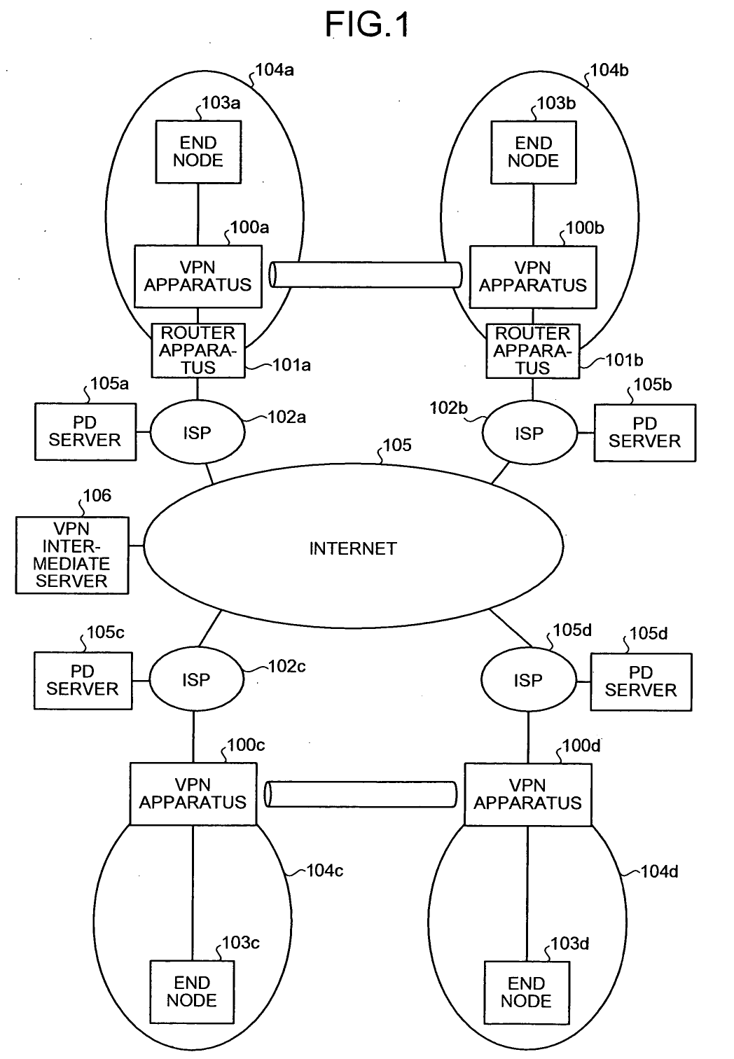

FIG. 1 is an explanatory view of a network configuration of a network system according to a first embodiment. As shown in FIG. 1, the network system of this embodiment has a form in which a plurality of VPN apparatuses 100a to 100d are connected to an Internet 107 via networks of ISPs (Internet Service Providers) 102a to 102d, and VPN connection is possible. PD (Prefix Delegation) servers 105a to 105d are connected networks of the ISPs 102a to 102d. Further, a VPN intermediate server 106 is connected on the Internet 107.

VPN which is used in this embodiment is Layer 2VPN achieved using a technique of a data link layer which is the second layer of the OSI basic reference model, and it is in the form of site-to-site VPN connecting a plurality of networks 104a to 104d.

The network system of this embodiment uses a communication protocol of TCP/IP and uses an IPv6 address format for the address.

The VPN apparatuses 100a to 100d perform processing of establishing VPN connection between networks 104a to 104d such as LAN (Local Area Network) managed by themselves, various kinds of processing such as tunneling compliant with a VPN protocol, and processing disconnecting VPN connection, and in this embodiment, it further performs processing of acquiring a VPN prefix which is a network prefix in the IPv6 format for use in communication by VPN.

The VPN apparatuses 100a and 100b have no router function, and are therefore connected to the Internet 107 via router apparatuses 101a and 101b. The VPN apparatuses 100c and 100d have a router function, and are therefore connected directly to the Internet 107 with no router apparatus therebetween. FIG. 1 shows an example in which VPN connection is established between networks of VPN apparatuses having no router function, namely between the network 104a of the VPN apparatus 100a and the network 104b of the VPN apparatus 100b, and VPN connection is established between networks of VPN apparatuses having a router function, namely between the network 104c of the VPN apparatus 100c and the network 104d of the VPN apparatus 100d, but the present invention is not limited thereto, and VPN connection may be established between the network 104a or 104b of the VPN apparatus 100a or 100b having no router function and the network 104c or 104d of the VPN apparatus 100c or 100d having a router function.

The PD servers 105a to 105d belong to networks of the ISPs 102a to 102d, receive a prefix acquirement request from a PD client, generate a network prefix and send the network prefix to the PD client. Here, the PD (Prefix Delegation) is a mechanism receiving a prefix acquirement request from the PD client and automatically assigning a global address space of IPv6 from the ISPs 102a to 102d, and in this embodiment, the network prefix can be assigned from the PD servers 105a to 105d with a PD client unit 214 of the VPN apparatus 100 described later serving as the PD client.

The VPN intermediate server 106 is a server determining whether VPN connection of two networks 104 is possible or not, and performing processing of sending the network prefix to the VPN apparatuses 100a to 100d of the networks 104a to 104d if it is determined that the VPN connection is possible.

Hereinafter, for the sake of convenience of explanation, each of the VPN apparatuses 100a to 100d will be represented as a VPN apparatus 100, each of the ISPs 102a to 102d will be represented as an ISP 102, each of the router apparatuses 101a and 101b will be represented as a router apparatus 101, each of the end nodes 103a to 103d will be represented as an end node 103, each of the networks 104a to 104d will be described as a network 104, and each of the PD servers 105a to 105d will be represented as a PD server 105.

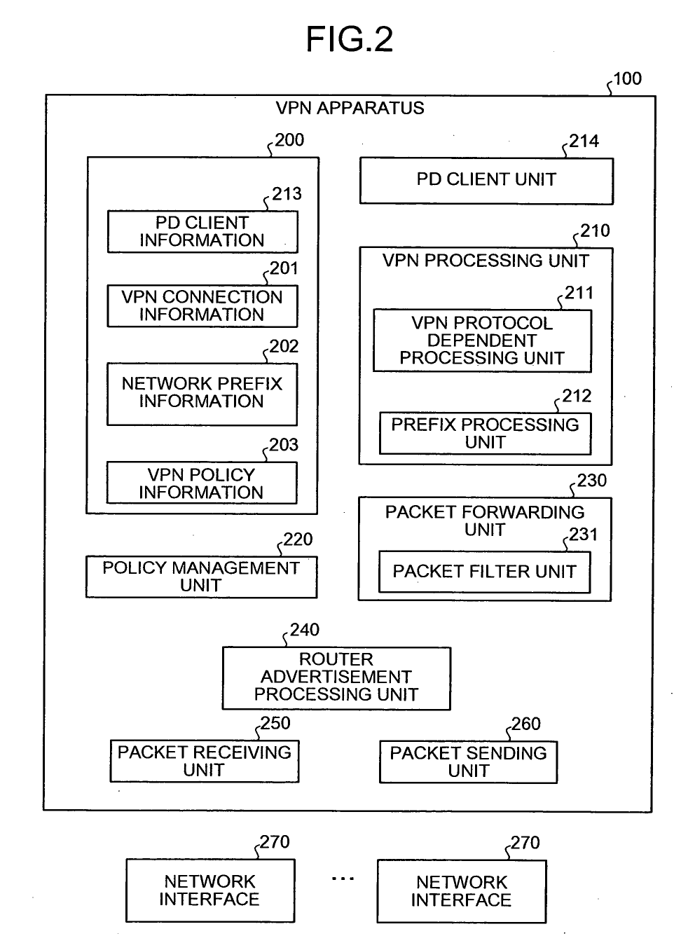

FIG. 2 is a block diagram showing a functional configuration of the VPB apparatus 100. As shown in FIG. 2, the VPN apparatus 100 includes principally a VPN processing unit 210, a policy management unit 220, a packet forwarding unit 230, a router advertisement processing unit 240, a packet receiving unit 250, a packet sending unit 260, a PD client unit 214, a storage unit 200, and a plurality of network interfaces 270.

The VPN processing unit 210 performs processing such as manipulation of VPN connection information 201 stored in the storage unit 200, and establishment and disconnection of VPN compliant with a VPN protocol. The VPN processing unit 210 comprises, a VPN protocol dependent processing unit 211 and a prefix processing unit 212. The VPN protocol dependent processing unit 211 performs processing related to establishment and disconnection of VPN connection, and processing of extracting a VPN prefix message described later from a message received from the VPN apparatus of the other party of connection. The processing related to establishment and disconnection of VPN connection varies for each protocol, but it is processing specified in IPsec (IP Security Protocol), such as tunneling of PPTP (Point-to-Point Tunneling Protocol), L2TP (Layer2 Tunneling Protocol) and the like.

The prefix processing unit 212 performs processing of determining a VPN prefix through negotiation by the sending/receiving of a VPN prefix message extracted by the VPN protocol dependent processing unit 211 with the VPN apparatus 100 of the other party of connection. Here, the VPN prefix is a network prefix in the IPv6 format which is used in communication by VPN.

Specifically, the prefix processing unit 212 performs superiority or inferiority determination,processing of determining a superior node performing processing of negotiating with the VPN apparatus 100 of the other party of connection to determine a VPN prefix and an inferior node receiving a notification of the determined VPN prefix, prefix acquirement method determination processing of determining a method for acquiring a network prefix, prefix distribution method determination processing of determining a method for distributing the determined VPN prefix, prefix distribution form determination processing of determining a form of distribution of the determined VPN prefix, and prefix acquirement processing of acquiring a network prefix by the acquirement method determined by the prefix acquirement method determination processing and determining a VPN prefix. Any of the superiority or inferiority determination processing, prefix acquirement method determining processing, prefix distribution method determination processing, prefix distribution form determination processing and prefix acquirement processing is processing related to determination of a VPN prefix. Prefix acquirement method determination processing, prefix distribution method determination processing and prefix distribution form determination processing are performed by the VPN apparatus 100 determined to be a superior node by superiority or inferiority determination processing, and the VPN apparatus 100 determined to be an inferior node is notified of the determination results.

The prefix processing unit 212 performs management of network prefix information 202, such as registration of network prefix information 202 in the VPN prefix. The prefix processing unit 212 performs processing of determining a VPN prefix at the time of processing of establishment of VPN connection, but it may perform processing of determining a VPN prefix in a series of procedures of the VPN protocol.

The VPN prefix message is a message sent and received for negotiation between VPN apparatuses 100 when a VPN prefix is determined, and its response message. The VPN prefix message is classified into a superiority or inferiority determination message, a prefix acquirement message and a prefix notification message. These messages are not limited to a single message sent and received between nodes establishing communication by VPN in one or more packet exchange operations, but a plurality of messages may be collectively sent and received. Further, message formats of these messages may be dependent on the message format of the VPN protocol and the message exchange system.

The superiority or inferiority determination message is a message for determining superiority or inferiority between nodes (VPN apparatuses 100) establishing VPN connection. For determination of superiority or inferiority, node IDs of both VPN apparatuses 100 are compared, and the VPN apparatus 100 having the higher node ID is determined to be a superior node and the VPN apparatus having the lower node ID is determined to be an inferior node. The node ID is an IP address or MAC address, or an identifier which can be uniquely determined, such as a random character string, and it may be an identifier other than the IP address or MAC address as long as it can be determined uniquely to some means. The method for determining superiority or inferiority is not limited to a method in which a determination is made according to the magnitude of the node ID as in this embodiment, but it may be any method in which superiority or inferiority is determined by exchanging some information capable of ordering between both parties. In addition, a superiority or inferiority determination function specified in the VPN protocol as a superiority or inferiority determination message may be used, and information allowing a determination to be made, other than a message of the IP address or the like, may be used to determine superiority or inferiority implicitly.

The prefix acquirement message is a message for sending and receiving various kinds of information necessary for negotiating on a network prefix or the like capable of being used in the networks 104 of VPN apparatuses 100 which are to establish VPN connection. The prefix acquirement message consists of four kinds of sub-messages: a prefix negotiation message, a prefix acquirement method message, a prefix distribution method message and a prefix distribution form message, based on information which is sent and received. The-message format and the like of each sub-message may be defined so as to match the system of the VPN protocol, and the format has no influence on the present invention.

The prefix negotiation message is a message showing whether or not negotiation on a network prefix is carried out, and a prefix acquirement method request message for inquiring of the VPN apparatus 100 of the other party of connection about whether negotiation on a prefix is possible or not and its response message correspond to the prefix negotiation message.

The prefix acquirement method message is a message for negotiating on a method for acquiring a network prefix when negotiation on a network prefix is carried out, and a prefix acquirement method request message for inquiring of the VPN apparatus 100 of the other party of connection about an available or desired method for acquiring, a prefix and its response message corresponds to the prefix acquirement method message.

The prefix distribution method message is a message for negotiating on a method for distributing a network prefix when negotiation on a network prefix is carried out, and a prefix distribution method request message for inquiring of the VPN apparatus 100 of the other party of connection about an available or desired method for distributing a prefix and its response message correspond to the prefix distribution method message.

The prefix distribution form message is a message for negotiating on a form of distribution of a network prefix when negotiation on a network prefix is carried out, and a prefix distribution form request message for inquiring of the VPN apparatus 100 of the other party of connection about an available or desired form of distribution of a prefix and its response message correspond to the prefix distribution form message.

The prefix notification message of the VPN prefix message is a message for notifying the VPN apparatus 100 of the inferior node of the other party of connection, of a VPN prefix assigned as a result of prefix acquirement processing in the VPN apparatus 100 of the superior node, together with a prefix acquirement method, a prefix distribution method and a prefix distribution form. The prefix notification message also includes a notification of rejection of VPN prefix negotiation.

Information necessary in processing the messages described above is stored as VPN policy information 203 in the storage unit 200 described later.

The policy management unit 220 manages VPN connection policy information 203 stored in the storage unit 200. Specifically, the policy management unit 220 performs processing of reading relevant information from VPN policy information 203 and passing the information to the prefix processing unit 212 when the above-mentioned VPN prefix message is generated by the prefix processing unit 212 and sent.

The router advertisement processing unit 240 performs processing of sending and receiving a router advertisement (RA: Router Advertisement) from within the network 104.

The packet receiving unit 250 performs processing of receiving a packet arriving at the network interface 270, and sorting packets according to the type of packet.

The packet sending unit 260 performs processing of receiving a packet to be sent to the network from within the VPN apparatus 100, and requesting an appropriate network interface 270 to send a packet.

The packet forwarding unit 230 performs processing of forwarding a packet between network interfaces 270. The packet forwarding unit 230 comprises a packet filter unit 231 performing processing of controlling the forwarded packet.

The PD client unit 214 performs processing of sending a request for acquirement of a network prefix using DHCPv6 (PD (Prefix Delegation) request) to the PD server present on the network side of the ISP 102 and registering a network prefix received from the PD server 105 in PD client information 213 of the storage unit 200, according to a command from the prefix processing unit 212, if the prefix acquirement method described later is “ISP.”

The network interfaces 270 are physical interfaces sending and receiving packets, and specifically network boards and the like correspond to the network interfaces 270. A virtual interface correlated to an appropriate network interface may be generated when communication with the VPN apparatus 100 of the other party of connection is established by the VPN protocol.

The storage unit 201 is a storage medium such as a memory or hard disk drive apparatus (HDD), and VPN connection information 201, network prefix information 202, VPN policy information 203 and PD client information 213 are stored therein. A network prefix received from the PD server 105 is registered in the PD client information 213.

The VPN policy information 203 is data in which a VPN policy being information related to processing of determining a VPN prefix by the prefix processing unit 212 is registered. The VPN policy information 203 is referenced by the policy management unit 220 according to a VPN prefix message at the time of generating the VPN prefix message when a VPN prefix is determined by the prefix processing unit 212, and is set each time VPN connection with the VPN apparatus 100 of the other party of connection is established.

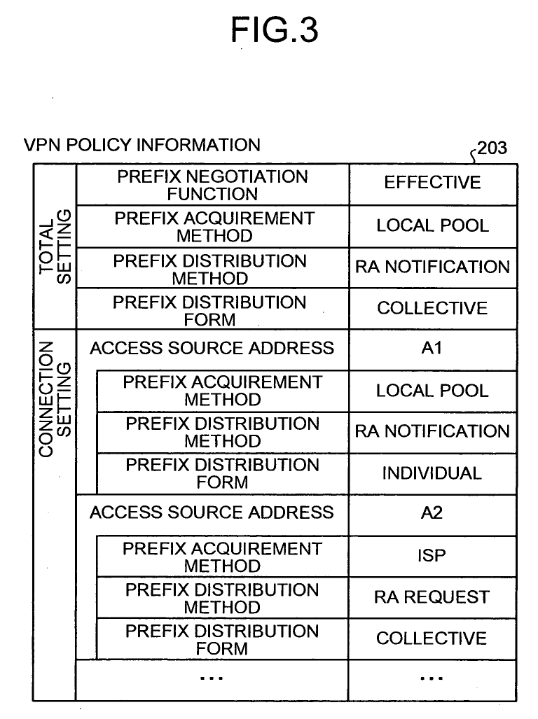

FIG. 3 is a data structure diagram showing a structure of VPN policy information 203. In the VPN policy information 203, a total setting being a VPN policy of the entire VPN apparatus 100 and a connection setting being a VPN policy for each VPN connection are registered as shown in FIG. 3.

For the total setting of VPN policy information 203, fields of a prefix negotiation function, the prefix acquirement method, the prefix distribution method and the prefix distribution form are provided. They function as standard operation settings of the entire system. The VPN policy information 203 is provided with fields of an access source address, the prefix acquirement method, the prefix distribution method and the prefix distribution form for each VPN connection. They are policies for the other party of VPN connection specified by the access source address, and has precedence over the total setting.

The prefix negotiation function field shows whether or not negotiation with the VPN apparatus 100 of the other party of connection is carried out when VPN prefix is determined, and “effective” is set if negotiation is possible, and “ineffective” is set if negotiation is impossible.

The prefix acquirement method field is a field in which the method for acquiring a network prefix is acquired, and is referenced at the time of generating a prefix acquirement method message. “Local pool,” “ISP,” “Unique Local IPv6 Unicast Address,” and “random” can be set in the field of the prefix acquirement method.

The “local pool” is a prefix acquirement method in which a network prefix is selected from network prefix information 202 managed within the self VPN apparatus 100 and determined as a VPN prefix.

The “ISP” is a prefix acquirement method in which a network prefix is acquired using the network of the ISP 102, and determined as a VPN prefix. Specifically, a request for acquirement of a network prefix (PD request) is made to the PD server 105 present on the network side of the ISP 102 by the PD client unit 214, and the network prefix is acquired from its response massage (PD response) is acquired. The network prefix assigned from the PD server 105 may be a network prefix other than the network prefix dependent on the network of the ISP 102 to which the VPN apparatus 100 making an acquirement request belongs, and the network prefix is assigned based on a contract between the ISP 102 and an ISP subscriber.

“Unique Local IPv6 Unicast Address” is a prefix acquirement method in which an address generated in accordance with the rule of Unique Local IPv6 Unicast Address which is a rule predefined in the IPv6 protocol is determined as a VPN prefix. The Unique Local IPv6 Unicast Address is a unique address capable of being used in a local area network.

“Random” is a prefix acquirement method in which network prefixes are randomly generated, and one that does not overlap the network prefix registered in network prefix information 202 managed in the self VPN apparatus 100 is determined as a VPN prefix.

Thus, in this embodiment, four prefix acquirement methods are prepared, but the prefix acquirement method is not limited to such methods, and any method may be employed as long as it allows a network prefix to be acquired effectively.

The four acquirement methods may be given priorities to perform the acquirement methods in the order of priority until a network prefix can be acquired. For example, priorities are set in the order of “local pool,” “ISP2 and “Unique Local IPv6 Unicast Address” with the highest priority given to “local pool,” and acquirement of a network prefix is first tried by the acquirement method of “local pool,” and if it cannot be acquired, then acquirement of the network prefix is tried by the acquirement method of “ISP,” and if the network prefix cannot be acquired by the method of “ISP,” acquirement of,the network prefix is performed by the method of “Unique Local IPv6 Unicast Address.”

The prefix distribution method field is a field in which a method for distributing a VPN prefix is set, and is referenced at the time of generating a prefix distribution method message. “RA notification” and “RA request” can be set in the field of the prefix distribution method.

The “RA notification” is a method in which a VPN prefix is distributed by sending a router advertisement (RA) specifying the VPN prefix into the self network 104 by the router advertisement processing unit 240.

The “RA request” is a method in which a VPN prefix is distributed by requesting the router apparatus 101 to distribute the VPN prefix by an RA. Specifically, an RA request message specifying the VPN prefix is sent to the router apparatus 101 by the router advertisement processing unit 240, and the router apparatus 101 receiving the RA request message sends the RA specifying the VPN prefix into the network 104, whereby the VPN prefix is distributed into the network 104.

The prefix distribution form field is a field in which a method for distributing a VPN prefix is set, and is referenced at the time of generating a prefix distribution form message. “Individual” and “collective” can be set in the field of the prefix distribution form.

The “individual” means individual distribution, and is a distribution form in which the RA is individually for each VPN-connected network, and a notification of the VPN prefix is provided. The VPN apparatus of each network provides the notification of the prefix under its own authority, and a notification of the VPN prefix by way of the VPN is never provided except for the case where a manager intentionally makes a setting. The VPN apparatus adjusts a packet filter unit provided in the apparatus to make a setting so that all RAs do not pass through the VPN.

“Collective” means collective distribution, and is a form in which one RA sending node is placed for all VPN-connected networks, and the node notifies all VPNs of the VPN prefix. In this case, The VPN apparatus 100 of the superior node or the router apparatus 102 receiving an RA request message from the VPN apparatus 100 of the superior node provides the notification of the VPN prefix. The VPN apparatus 100 adjusts the packet filter unit 231 to make a setting so that an RA advertising a prefix other than the VPN prefix or prefix permitted by the manager does not pass through the VPN.

The address of an access source of connection setting of VPN policy information 203 is the address of the VPN apparatus 100 of the other party of connection.

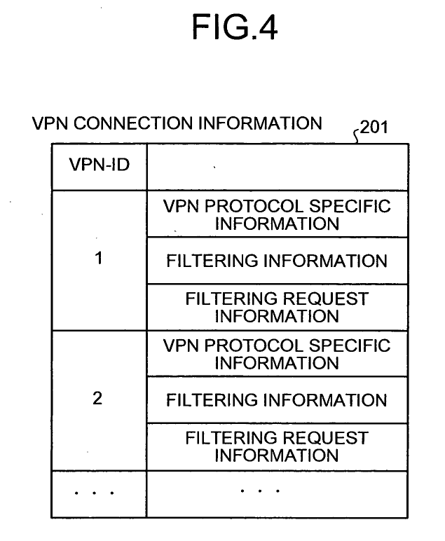

The VPN connection information 201 is information in which data related to packet filtering in VPN connection is registered for each VPN connection. FIG. 4 is an explanatory view showing one example of a structure of the VPN connection information 201. As shown in FIG. 4, in VPN connection information 201, VPN protocol specific information showing various kinds of data related to the VPN protocol, filtering information showing the contents of packet filter setting, and filtering request information being data of packet filtering which is requested to the router apparatus 101 are registered for each VPN-ID for identifying each VPN connection.

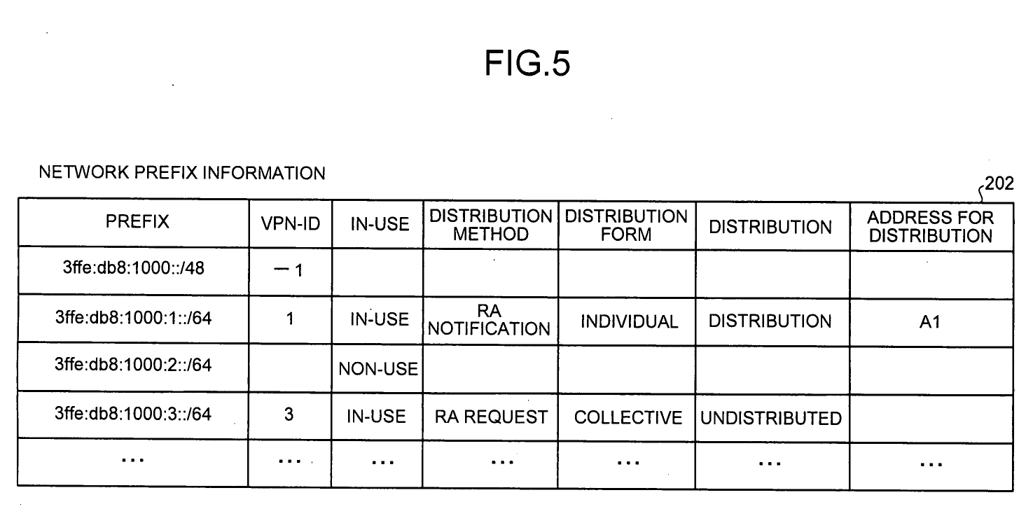

The network prefix information 202 is a data file in which network prefixes managed by the VPN apparatus 100 are registered. FIG. 5 is an explanatory view showing one example of a structure of network prefix information 202. As shown in FIG. 5, the network prefix information 202 is provided with fields of the prefix, the VPN-ID, in-use, the distribution method, the distribution form, distribution and the address for distribution in correlation of one to another. The network prefix information 202 has information set by the prefix processing unit 212.

The prefix field is a field showing a network prefix managed within the VPN apparatus 100.

The VPN-ID field is a field showing specific identification information for identifying each VPN connection. “−1” is set to the network prefix of the prefix field connected to the other node but not by the VPN protocol.

The in-use field is a field showing whether or not the network prefix of the prefix filed is already used in VPN connection as a VPN prefix, and if it is already used in VPN connection as a VPN prefix, “in-use” is set, and if it is not used as a VPN prefix, “unused” is set.

The distribution method field is a field showing a method for distributing the network prefix of the prefix field VPN-connected and determined as a VPN prefix. The above-mentioned “RA notification” or “RA request” is set in the distribution method field.

The distribution form field is a field showing a form of distribution of the network prefix of the prefix field VPN-connected and determined as a VPN prefix. “Individual” or “collective” is set in the distribution form field.

The distribution field is a field showing whether or not the network prefix VPN-connected and determined as a VPN prefix has been distributed, and if it has been distributed according to a router advertisement or router request, “distributed” is set, and if it has not been distributed yet, “undistributed” is set.

The address field for distribution is a field in which a link local address exclusively for distribution of a VPN prefix is set if such a link local address is used when a network prefix determined as the VPN prefix is distributed. If the link local address exclusively for distribution of the VPN prefix is not used, none is set in the address field for distribution.

In the example shown in FIG. 5, the prefix “3ffe:db8:1000:1::/64” is a notification by the VPN apparatus, and shows that individual distribution for each network is performed, and the VPN apparatus distributes the prefix using an address of A1. The prefix “3ffe:db8:1000:1::/64” shows that RA request and collective distribution are performed, and the node managing the table of FIG. 5 does not perform distribution. Because distribution is not performed, the column for the address for distribution is blank. The columns for the unused prefix and the total prefix are blank, showing that they have no values.

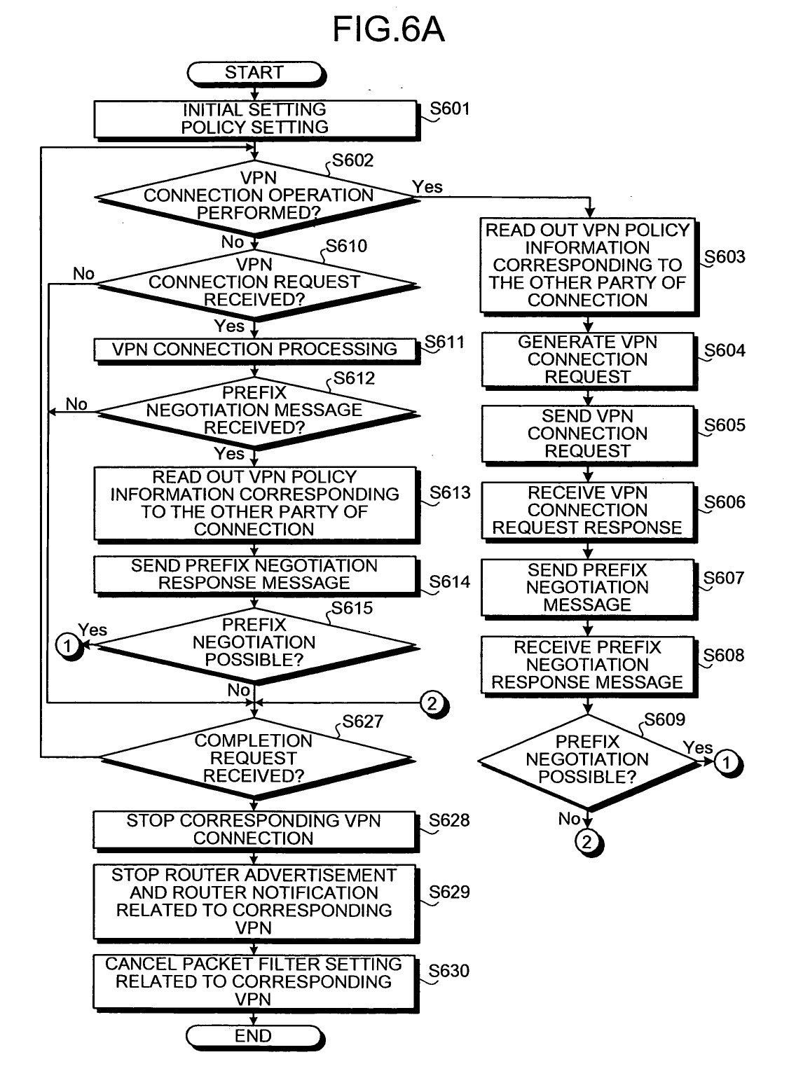

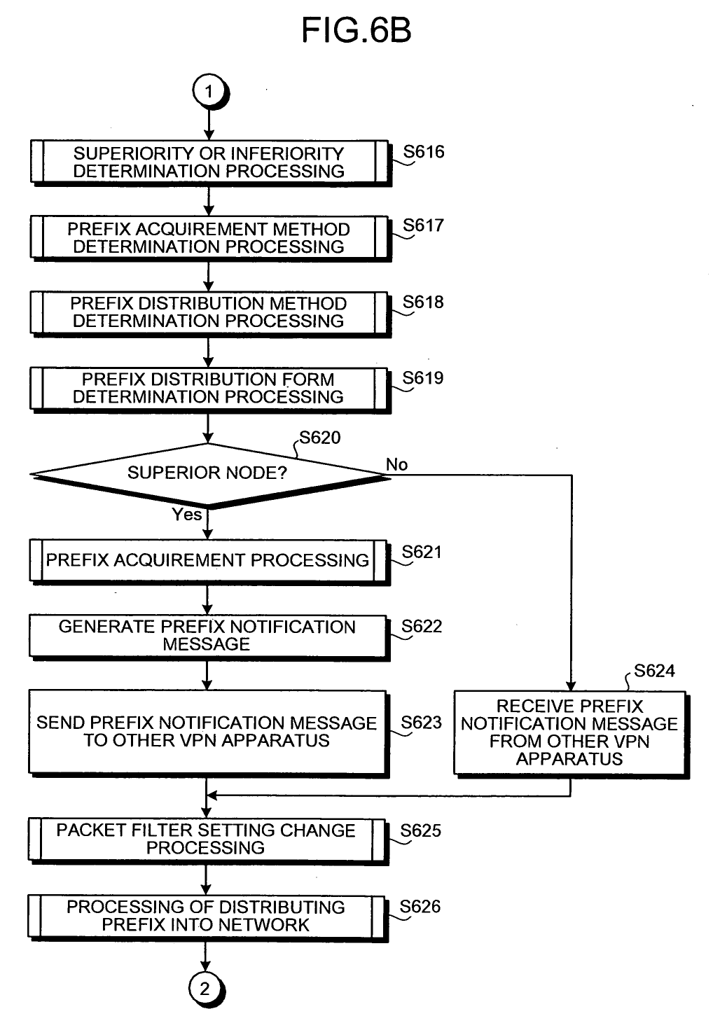

Prefix determination processing by the VPN apparatus 100 according to this embodiment configured as described above will now be described. FIGS. 6A and 6B are flowcharts showing a procedure of total processing of determination of a prefix by the VPN apparatus 100 according to the embodiment.

The VPN apparatus 100 performs initial setting by the VPN protocol dependent processing unit 211 and policy setting by the policy management unit 220 (step S601). Whether or not a VPN connection operation has been done by a user is determined (step S602), and if the VPN connection operation has been done (step S602: Yes), processing on the VPN connection request side in processing of establishment of VPN connection is started. Namely, a series of entries identified by the access source address of the other party of connection in connection setting of VPN policy information 203 (hereinafter referred to as “VPN policy information 203 corresponding to the other party of connection”) is read out by the policy management unit 220 (step S603). A VPN connection request message is generated by the VPN protocol dependent unit 211 based on the VPN policy information 203 read out (step S604), and the PVN connection request message is sent to the VPN apparatus 100 of the other party of connection by the packet sending unit 260 (step S605).

Then, a VPN connection request response message to the VPN connection request message is received from the VPN apparatus 100 of the other party of connection by the packet receiving unit 250 (step S606), and a prefix negotiation function of VPN policy information corresponding to the other party of connection, read out at step S603, and a self prefix negotiation function from total setting of VPN policy information 203 are specified, and a prefix negotiation message is generated and sent to the VPN apparatus 100 of the other party of connection by the prefix processing unit 212 (step S607).

Then, a prefix negotiation response message to the prefix negotiation message is received (step S608), and whether or not the contents of the prefix negotiation function of the other party of connection included in the received prefix negotiation response message and the self prefix negotiation function in total setting of policy information 203 are both effective is determined by the prefix processing unit 212, whereby whether prefix negotiation is possible or not is determined (step S609).

If the prefix negotiation function of the other party of connection and the self prefix negotiation function are both effective, it is determined that prefix negotiation is possible (step S609: Yes), and processing proceeds to superiority or inferiority determination processing in step S616.

If any the prefix negotiation function of the other party of connection and the self prefix negotiation function is ineffective at step S609 (step S609: No), processing of determining a prefix is not continued, and processing is in a state of waiting for reception of a completion request in step S627. At this time, further, an error massage indicating that prefix negotiation is impossible may be sent to the other party of connection.

Processing returns to step S602, and if the VPN connection operation has not been done (step S602: No), processing on the side of waiting for a VPN connection request in processing of establishing VPN connection is started. Namely, reception of a VPN connection request is waited for by the VPN protocol dependent processing unit 211 (step S610). If the VPN connection request is received, VPN connection processing is performed with the VPN apparatus 100 of the other party of connection according to the VPN protocol using a publicly known method by the VPN protocol dependent processing unit 211 (step S611). In this VPN connection processing, processing dependent on the VPN protocol, such as processing of reading out VPN policy information 203 corresponding to the VPN apparatus 100 of the other party of connection (connection setting of the other party of connection) by the VPN connection request message, processing of establishing connection by the VPN protocol, and processing of sending a VPN connection request response message indicating that VPN connection has been normally established to the received VPN connection request message to the VPN apparatus 100 making the connection request, is performed.

Then, the VPN protocol dependent processing unit 211 determines whether or not the prefix negotiation message has been received (step S612). Here, the prefix negotiation message is not necessarily received separately from the VPN connection request message, but may be included in a message received in processing compliant with a normal VPN protocol, such as the received VPN connection request message, and in this case, the prefix negotiation message is extracted from the message received by the VPN protocol dependent processing unit 211.

VPN policy information 203 corresponding to the VPN apparatus 100 of the other party of connection (a series of entries of connection setting identified by the access source address of the other party of connection in VPN policy information 203) is read out by the policy management unit 220 (step S613). If the connection setting of the access source address of the other party of connection is not present in VPN policy information 203, the total setting of VPN policy information 203 is read out. A prefix negotiation response message including the prefix negotiation function of VPN policy information 203 is sent to the VPN apparatus 100 of the other party of connection which has sent the prefix negotiation message (step S614).

Then, whether or not the contents of the prefix negotiation function of the other party of connection included in the prefix negotiation response message received at step S612 and the self prefix negotiation function in total setting of policy information 203 are both effective is determined by the prefix processing unit 212, whereby whether prefix negotiation is possible or not is determined (step S615).

If the prefix negotiation function of the other party of connection and the self prefix negotiation function are both effective, it is determined that prefix negotiation is possible (step S615: Yes), and processing proceeds to superiority or inferiority determination processing in step S616.

If any the prefix negotiation function of the other party of connection and the self prefix negotiation function is ineffective at step S615 (step S615: No), processing of determining a prefix is not continued, and processing is in a state of waiting for reception of a completion request in step S627. At this time, further, an error massage indicating that prefix negotiation is impossible may be sent to the other party of connection.

If it is determined that prefix negotiation is possible at step S609 in the VPN apparatus 100 on the side of sending the VPN connection request (step S609: Yes), and it is determined that prefix negotiation is possible at step S615 in the VPN apparatus 100 on the side of waiting for the VPN connection request (step S615: Yes), superiority or inferiority determination processing of determining a superior ode performing a VPN prefix and an inferior node receiving a notification of the determined VPN prefix is performed (step S616).

When superiority or inferiority determination processing is performed to determine the superior node and the inferior node, then prefix acquirement method determination processing of determining a method for acquiring a network prefix (step S617), prefix distribution method determination processing of determining a method for distributing the determined VPN prefix (step S618) and prefix distribution form determination processing of determining a form of distribution of the determined VPN prefix (step S619) are sequentially performed by the prefix processing unit 212. Details of superiority or inferiority determination processing, prefix acquirement method determination processing, prefix distribution method determination processing and prefix acquirement form determination processing will be described later.

When prefix distribution form determination processing is performed, then whether or not the self VPN apparatus 100 has been determined to be a superior node is determined by the prefix processing unit 212 (step S620).

If the self VPN apparatus 100 is a superior node (step S620: Yes), prefix acquirement processing of acquiring a network prefix to determine a VPN prefix is performed by the prefix processing unit 212 (step S621). Details of prefix acquirement processing will described later.

By the prefix processing unit 212, a prefix notification message for notifying the VPN apparatus 100 of the other party of connection, of the VPN prefix determined in prefix acquirement processing is generated (step S622), and the generated prefix notification message is sent to the VPN apparatus 100 of the other party of connection (step S623).

If the self VPN apparatus 100 is an inferior node at step S620 (step S620: No), the prefix notification message including the VPN prefix determined by the VPN apparatus 100 of the superior node is sent by the packet receiving unit 250 (step S624).

Next, processing of changing the packet filter setting is performed by the packet filter unit 231 (step S625), and then processing of distributing the determined VPN prefix into the network 104 managed by the VPN apparatus 100 is performed by the router advertisement processing unit 240 (step S626). Details of processing of changing the packet filter setting and processing of distributing the prefix will be described later.

When processing of distributing the prefix is completed, then processing is in a state of waiting for reception of a completion request (step S627). When the completion request is received, the corresponding VPN connection is stopped (step S628), the corresponding VPN related RA is stopped (step S629) and further, the corresponding VPN related packet filter setting is cancelled (step S630).

As described above, when VPN connection is established, negotiation is carried out by sending and receiving a prefix message from the VPN apparatus 100 of the other party of connection, and a VPN prefix being a network prefix for use in communication of the VPN is determined and distributed into the network 104.

The flow of determination of the VPN prefix described above will described taking two PVN apparatuses 100 which are VPN-connected as an example. First, the case where VPN connection is established between VPN apparatuses 100c and 100d having a router function and a prefix is determined will be described.

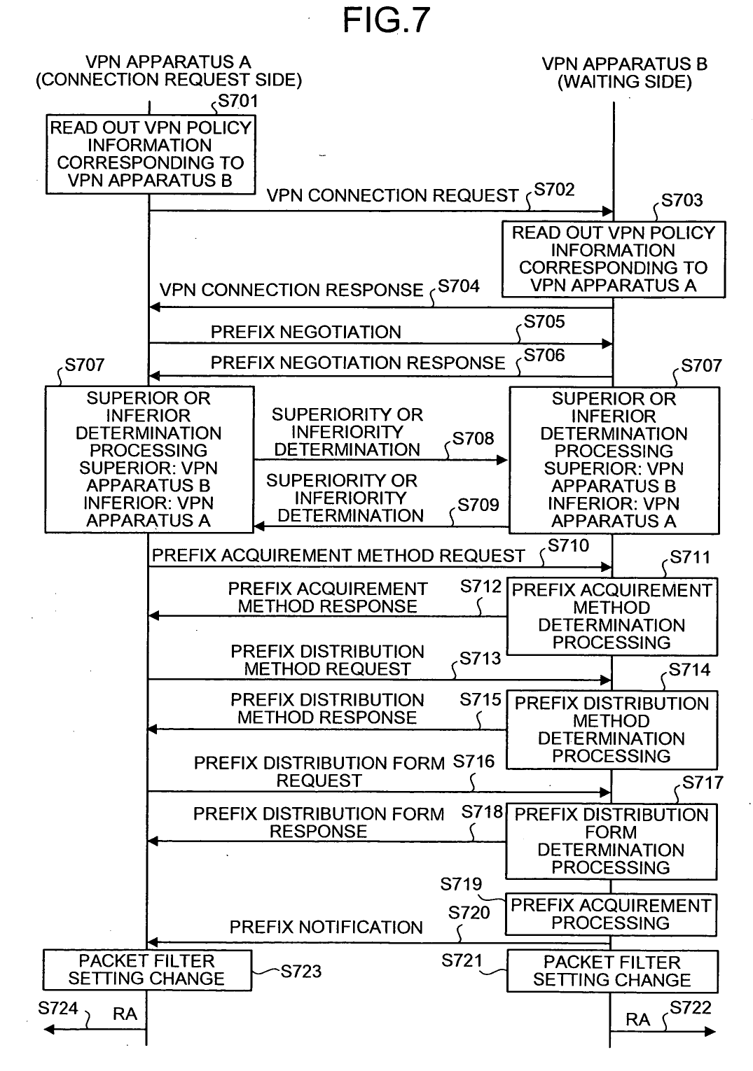

FIG. 7 is a sequence diagram showing an exchange of a message sent and received in prefix determination processing between VPN apparatuses 100c and 100d having a router function according to the first embodiment. Here, the VPN apparatus making a VPN connection request is VPN apparatus A, and the VPN apparatus waiting for VPN connection is VPN apparatus B.

In the VPN apparatus A on the connection request side, VPN policy information 203 corresponding to the VPN apparatus B being the other party of connection (connection setting of VPN apparatus B) is read out by the policy management unit 220 (step S701). A VPN connection request message is sent to the VPN apparatus B by the VPN protocol dependent processing unit 211 (step S702). In the VPN apparatus B, the VPN connection request message is received, and then VPN policy information 203 corresponding to the VPN apparatus A being the other party of connection (connection setting of VPN apparatus A) is read out by the policy management unit 220 (step S703). Connection processing compliant with the VPN protocol is performed by the VPN protocol dependent processing unit 211, and a VPN connection response message is sent to the VPN apparatus A (step S704).

In the VPN apparatus A, a prefix negotiation message is sent to the VPN apparatus B by the prefix processing unit 212 (step S705), and in the VPN apparatus B which has received the message, whether prefix negotiation is possible or not is determined by the prefix processing unit 212 and as its response, a prefix negotiation response message is sent to the VPN apparatus A (step S706).

Next, in each of the VPN apparatus A and the VPN apparatus B, superiority or inferiority determination processing described later is performed by the prefix processing unit 212 (step S707). In this superiority or inferiority determination processing, a superiority or inferiority determination message specifying a node ID of itself is sent and received between two VPN apparatuses (steps S708 and S709). In the example of FIG. 7, the superior node is determined to be the VPN apparatus B and the inferior node is determined to be the apparatus A.

Next, the VPN apparatus A of the inferior node sends a prefix acquirement method request message specifying a prefix acquirement method which can be used or is desired by itself to the VPN apparatus B by the prefix processing unit 212 (step S710). The VPN apparatus B of the superior node, which has received the prefix acquirement method request message, performs processing of determining a prefix acquirement method based on the prefix acquirement request message received by the prefix processing unit 212 and VPN policy information 203 (total setting) of itself (step S711), and sends to the VPN apparatus A of the inferior node a response message to the prefix acquirement method request specifying the determined prefix acquirement method (step S712). In the example of FIG. 7, “local area” is determined as a prefix acquirement method.

Next, the VPN apparatus A sends a prefix distribution method request message specifying a prefix distribution method which can be used or is desired by itself to the VPN apparatus B by the prefix processing unit 212 (step S713). The VPN apparatus B of the superior node, which has received the prefix distribution method request message, performs processing of determining a prefix distribution method based on the prefix distribution method request message received by the prefix processing unit 212 and VPN policy information 203 (total setting) of itself (step S714), and sends to the VPN apparatus A of the inferior node a response message to the prefix distribution method request specifying the determined prefix distribution method (step S715). In the example of FIG. 7, “RA notification” is determined as a prefix distribution method.

Next, the VPN apparatus A sends a prefix distribution form request message specifying a prefix distribution form which can be used or is desired by itself to the VPN apparatus B by the prefix processing unit 212 (step S716). The VPN apparatus B of the superior node, which has received the prefix distribution method request message, performs processing of determining a prefix distribution form based on the prefix distribution form request message received by the prefix processing unit 212 and VPN policy information 203 (total setting and connection setting identified by the address of the VPN apparatus A (access source address) in VPN policy information 203) of itself (step S717), and sends to the VPN apparatus A of the inferior node a response message to the prefix distribution form request specifying the determined prefix distribution form (step S718). In the example of FIG. 7, “individual” is determined as a prefix distribution form.

Thereafter, the VPN apparatus B performs a prefix acquirement processing to determined a VPN prefix (step S719), and sends a prefix notification message specifying the determined VPN prefix to the VPN apparatus A of the inferior node (step S720), by the prefix processing unit 212. Processing of changing the packet filter setting is performed based on the VPN prefix by the packet filter unit 231 (step S721), and an RA specifying the VPN prefix is sent into the self network 104 by the router advertisement processing unit 240, whereby the VPN prefix is distributed (step S722).

In the VPN apparatus A notified of the VPN prefix by the prefix notification message, processing of changing the packet filter setting is performed based on the VPN prefix by the packet filter unit 231 (step S723), and the router advertisement (RA) specifying the VPN prefix is sent into the self network 104 by the router advertisement processing unit 240, the VPN prefix is distributed (step S724).

In this way, negotiation for determining a prefix is carried out between the VPN apparatus A and the VPN apparatus B, and a VPN prefix is determined and distributed into the network. If “collective” is determined as a prefix distribution form, the VPN prefix is distributed by the RA not only into the network 104 of the VPN apparatus B but also into the network 104 of the VPN apparatus A from the VPN apparatus B being a superior node.

FIG. 7 shows an example in which negotiation for determining a prefix is carried out between VPN apparatuses 100c and 100d having a router function according to the embodiment and now, an exchange of negotiation for determining a prefix between VPN apparatuses 100a and 100b having no router function according to the embodiment will be described.

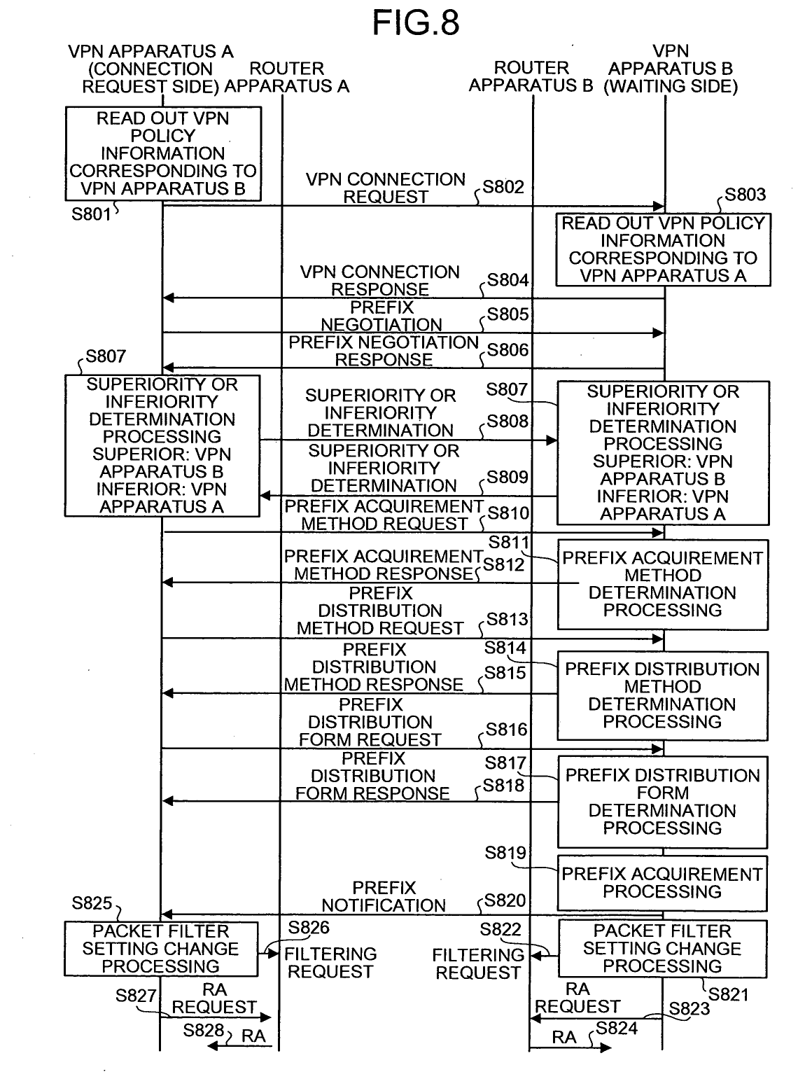

FIG. 8 is a sequence diagram showing an exchange of a message sent and received in prefix determination processing between VPN apparatuses 100a and 100c having no router function according to the first embodiment. Here, the VPN apparatus making a VPN connection request is the VPN apparatus A, and the VPN apparatus on the side of waiting for the VPN connection request is the VPN apparatus B. The router apparatus within the network of the VPN apparatus A is router apparatus A, and the router apparatus within the network of the VPN apparatus B is router apparatus B.

VPN policy information 203 is read out by the VPN apparatus A on the side of making the VPN connection request, and processing from the sending of the VPN connection request message to the notification of the prefix by the VPN apparatus B being a superior node (steps S801 to S820) is performed in the same manner as in the example of FIG. 7 (steps S701 to S720). Here, in the example of FIG. 8, “local pool” is determined as a prefix acquirement method, “RA request” is determined as a prefix distribution method, and “individual” is determined as a prefix distribution form, respectively as a result of negotiation between both VPN apparatuses.

When a prefix notification message specifying the determined VPN prefix is sent to the VPN apparatus A of the inferior node by the VPN apparatus B, processing of changing the packet filter setting is performed based on the VPN prefix by the packet filter unit 231 (step S821), and a filtering request for changing the packet filter setting is sent to the router apparatus B (step S822). In the router apparatus B, the packet filter setting is changed based on the contents of the received filtering request.

Next, the VPN apparatus B sends an RA request message specifying the VPN prefix to the router apparatus B by the router advertisement processing unit 240 (step S823). The router apparatus B, which has received the RA request message, sends an RA including the VPN prefix specified in the RA request message into the network 104 and thereby distributes the RA (step S824).

In the VPN apparatus A notified of the VPN prefix by the prefix notification message, processing of changing the packet filter setting is performed based on the VPN prefix by the packet filter unit 231 (step S825), and a filtering request for changing the packet filter setting is sent to the router apparatus B (step S826). In the router apparatus B, the packet filter setting is changed based on the contents of the received filtering request.

Next, the VPN apparatus B sends an RA request message specifying the VPN prefix to the router apparatus B by the router advertisement processing unit 240 (step S827). The router apparatus B, which has received the RA request message, sends an RA including the specified in the RA request message into the network 104 and thereby distributes the RA (step S828).

In this way, negotiation for determining a prefix is carried out between the VPN apparatus A and the VPN apparatus B, and a VPN prefix is determined and distributed into the network.

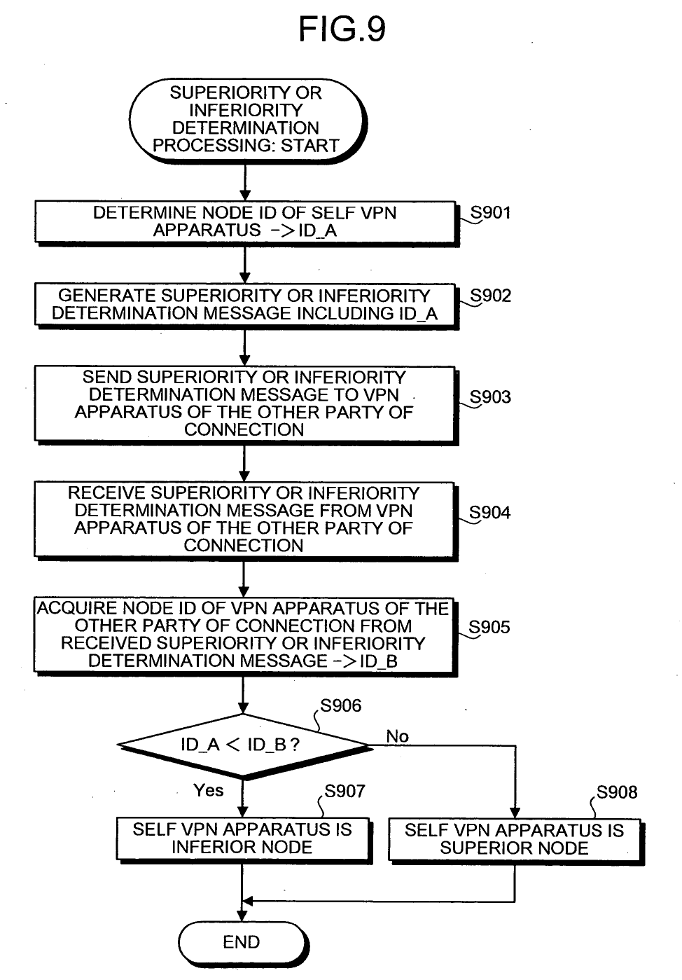

Superiority or inferiority determination processing by the prefix processing unit 212 in step S616 in total processing of determining a prefix will now be described. FIG. 9 is a flowchart showing a procedure of superiority or inferiority determination processing by the prefix processing unit 212.

First, the prefix processing unit 212 determines a node ID of the self VPN apparatus 100 to be ID_A (step S901). Here, the node ID is a value capable of ordering, such as an IP address or an ID specific to the VPN protocol. Any value other than the IP address and the ID specific to the VPN protocol may be employed as a node ID as long as it is capable of ordering.

Next, a superiority or inferiority determination message including ID_A is generated by the prefix processing unit 212 (step S902), the generated superiority or inferiority determination message is sent to the VPN apparatus 100 of the other party of connection by the packet sending unit 260 (step S903). The VPN apparatus 100 of the other party of connection which has received such a message, the superiority or inferiority determination message including the node ID of the VPN apparatus 100 of the other party of connection itself is sent, and therefore this message is received by the packet receiving unit 250 (step S904). The node ID of the other part of connection is acquired from the received superiority or inferiority determination message by the prefix processing unit 212, and the node ID is determined to be ID_B (step S905).

Next, by the prefix processing unit 212, ID_A being the self node ID is compared with the node ID of the other party of connection to check whether or not ID_A is lower than ID_B (step S906).

If ID_A is lower than ID_B (step S906: Yes), it is determined that the self VPN apparatus 100 is an inferior node (the VPN apparatus.100 of the other party of connection is a superior node) (step S907). If ID_A is higher than ID_B (step S906: No), it is determined that the self VPN apparatus 100 is a superior node (the VPN apparatus 100 of the other party of connection is an inferior node) (step S908).

Such superiority or inferiority determination processing is performed by two VPN-connected VPN apparatuses 100, respectively.

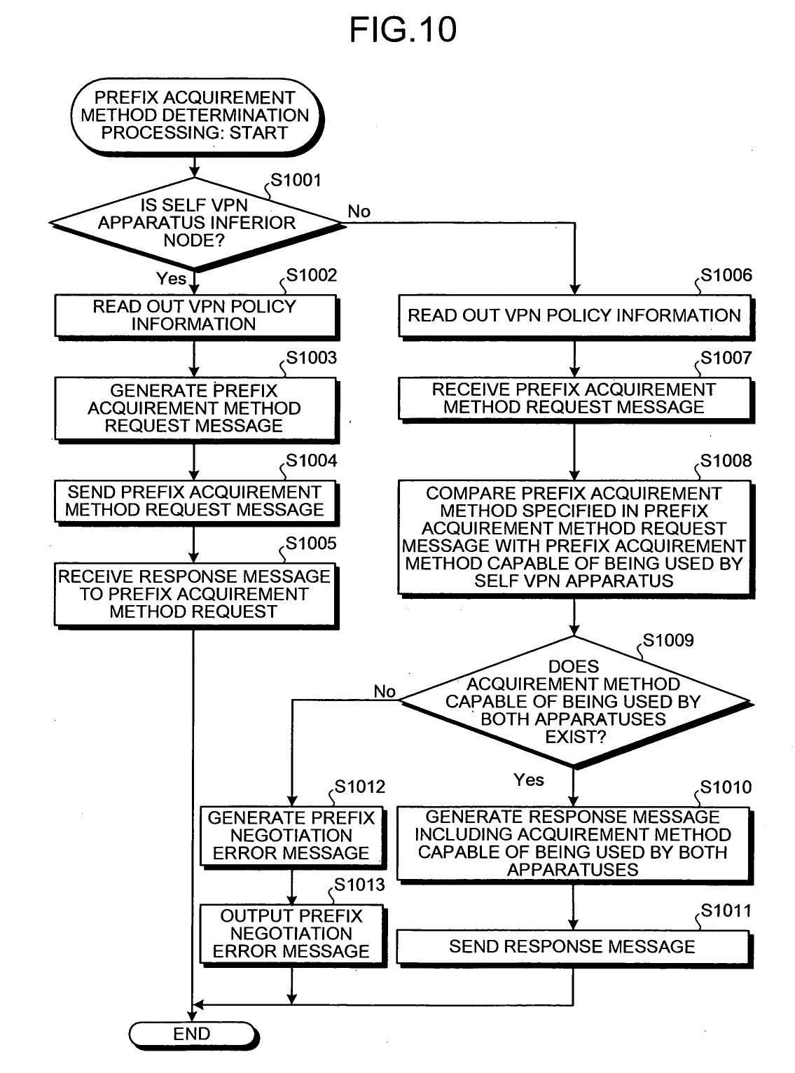

Prefix acquirement method determination processing in step S617 in total processing of determination a prefix will now be described. FIG. 10 is a flowchart showing a procedure of prefix acquirement method determination processing.

First, whether or not the self VPN apparatus 100 is an inferior node is determined by the prefix processing unit 212 (step S1001). If it is an inferior node (step S1001: Yes), VPN policy information 203 is read out by the policy management unit 220 (step S1002). A prefix acquirement method request message specifying a prefix acquirement method which is registered in VPN policy information 203, and can be used or is desired by the self VPN apparatus 100 is generated (step S1003), and the generated prefix acquirement method request message is sent to the VPN apparatus 100 by the packet sending unit 260 (step S1004). A response message to the prefix acquirement method request message is received from the VPN apparatus 100 of the other party of connection which is a superior node, by the packet receiving unit 250 (step S1005). The response message to the prefix acquirement method request message includes the prefix acquirement method determined by prefix acquirement method determination processing (steps S1006 to S1010 described later) in the VPN apparatus 100 of the superior node.

Processing returns to step S1001, and if the self VPN apparatus 100 is a superior node (step S1001: No), VPN policy information 203 is read out by the policy management unit 220 (step S1006). By the packet receiving unit 250, the prefix acquirement method request message is received from the VPN apparatus 100 of the other party of connection which is an inferior node (step S1007).

The received prefix acquirement method request message includes a prefix acquirement method which can be used or is desired by the VPN apparatus 100 of the other party of connection as described with step S1003, and therefore by the prefix processing unit 212, the prefix acquirement method specified in the prefix acquirement method request message is compared with the prefix acquirement method which is registered in the total setting of VPN policy information 203 and the connection setting identified by the address of the other party of connection (access source address), and can be used or is desired by the self apparatus 100 (step S1008).

Whether or not a prefix acquirement method capable of being used by both VPN apparatuses exists as a result of the comparison is checked by the prefix processing unit 212 (step S1009). If a prefix acquirement method capable of being used by both VPN apparatuses exists (step S1009: Yes), a response message including the prefix acquirement method capable of being used by both VPN apparatuses is generated by the prefix processing unit 212 (step S1010), and the generated response message is sent to the VPN apparatus 100 of the other party of connection which is an inferior node, by the packet sending unit 260 (step S1011).

If a prefix acquirement method capable of being used by both VPN apparatuses does not exist at step S1009 (step S1009: No), the prefix processing unit 212 generates a prefix negotiation error message (step S1012), and such an error message is sent to the VPN apparatus 100 of the other party of connection by the packet sending unit 260 (step S1013).

In this way, a prefix acquirement method message (prefix acquirement method request message and its response message) is sent and received between both VPN apparatuses 100, whereby a prefix acquirement method is negotiated and determined.

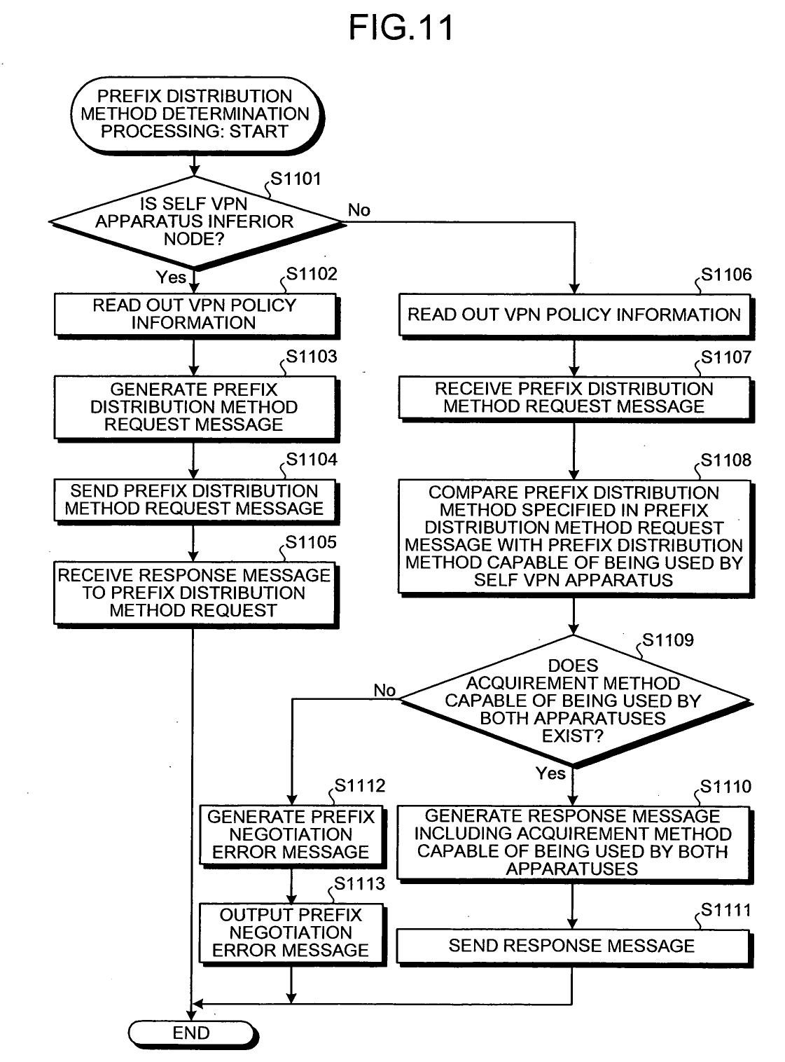

Prefix distribution method determination processing in step S618 in total processing of determining a prefix will now be described. FIG. 11 is a flowchart showing a procedure of prefix distribution method determination processing.

First, whether or not the self VPN apparatus 100 is an inferior node is determined by the prefix processing unit 212 (step S1101). If it is an inferior node (step S1101: Yes) VPN policy information 203 is read out by the policy management unit 220 (step S1102). A prefix distribution method request message specifying a prefix distribution method which is registered in VPN policy information 203, and can be used or is desired by the self VPN apparatus 100 is generated (step S1103), and the generated prefix distribution method request message is sent to the VPN apparatus 100 of the other party of connection by the packet sending unit 260 (step S1104). By the packet receiving unit 250, a response message to the prefix distribution method request message is received from the VPN apparatus 100 of the other party of connection which is a superior node (step S1105). The response message to the prefix distribution method request message includes the prefix distribution method determined by prefix distribution method determination processing (steps S1106 to S1110 described later) in the VPN apparatus 100 of the superior node.

Processing returns to step S1101, and if the self VPN apparatus 100 is a superior node (step S1101: No), VPN policy information 203 is read out by the policy management unit 220 (step S1106). By the packet receiving unit 250, the prefix distribution method request message is received from the VPN apparatus 100 of the other party of connection which is an inferior node (step S1107).

The received prefix distribution method request message includes a prefix distribution method which can be used or is desired by the VPN apparatus 100 of the other party of connection as described with step S1103, and therefore by the prefix processing unit 212, the prefix distribution method specified in the prefix distribution method request message is compared with the prefix distribution method which is registered in the total setting of VPN policy information 203 and the connection setting identified by the address of the other party of connection (access source address), and can be used or is desired by the self apparatus 100 (step S1108).

Whether or not a prefix distribution method capable of being used by both VPN apparatuses exists as a result of the comparison is checked by the prefix processing unit 212 (step S1109). If a prefix distribution method capable of being used by both VPN apparatuses exists (step S1109: Yes), a response message including the prefix distribution method capable of being used by both VPN apparatuses is generated by the prefix processing unit 212 (step S1110), and the generated response message is sent to the VPN apparatus 100 of the other party of connection which is an inferior node, by the packet sending unit 260 (step S1111).

If a prefix distribution method capable of being used by both VPN apparatuses does not exist at step S1109 (step S1109: No), the prefix processing unit 212 generates a prefix negotiation error message (step S1112), and such an error message is sent to the VPN apparatus 100 of the other party of connection by the packet sending unit 260 (step S1113).

In this way, a prefix distribution method message (prefix distribution method request message and its response message) is sent and received between both VPN apparatuses 100, whereby a prefix distribution method is negotiated and determined.

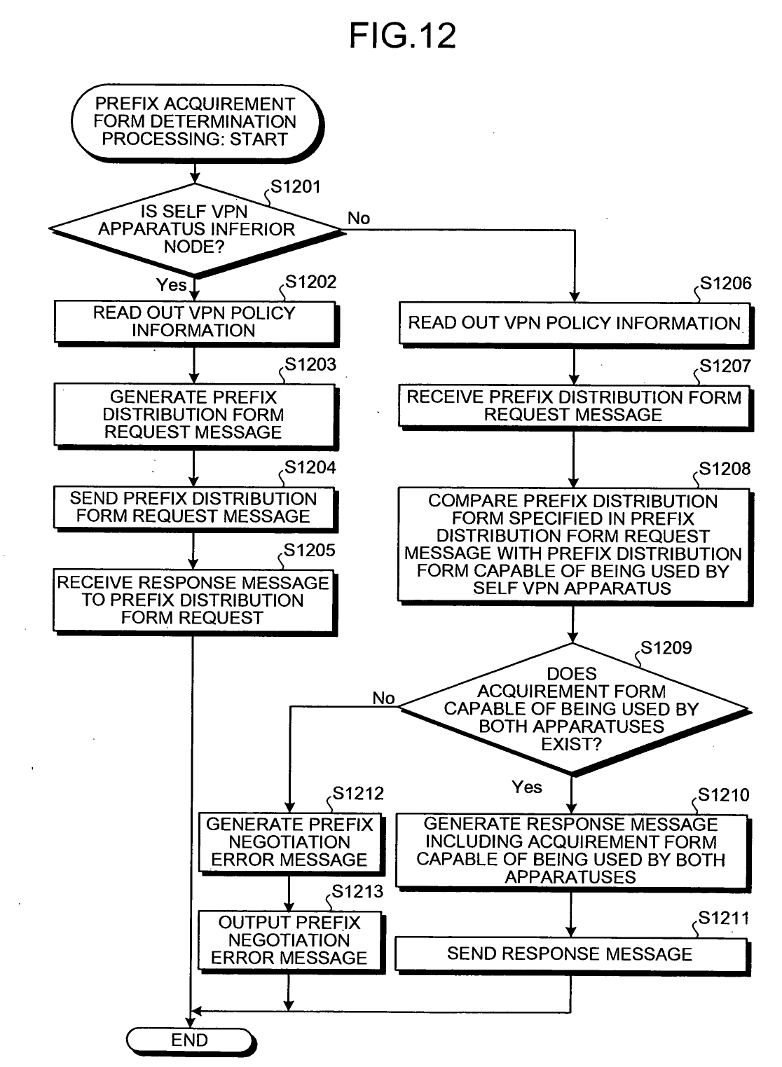

Prefix distribution form determination processing in step S619 in total processing of determining a prefix will now be described. FIG. 12 is a flowchart showing a procedure of prefix distribution form determination processing.

First, whether or not the self VPN apparatus 100 is an inferior node is determined by the prefix processing unit 212 (step S1201). If it is an inferior node (step S1201: Yes), VPN policy information 203 is read out by the policy management unit 220 (step S1202). A prefix distribution form request message specifying a prefix distribution form which is registered in VPN policy information 203, and can be used or is desired by the self VPN apparatus 100 is generated (step S1203), and the generated prefix distribution form request message is sent to the VPN apparatus 100 of the other party of connection by the packet sending unit 260 (step S1204). By the packet receiving unit 250, a response message to the prefix distribution form request message is received from the VPN apparatus 100 of the other party of connection which is a superior node (step S1205). The response message to the prefix distribution form request message includes the prefix distribution form determined by prefix distribution form determination processing (steps S1206 to S1210 described later) in the VPN apparatus 100 of the superior node.

Processing returns to step S1201, and if the self VPN apparatus 100 is a superior node (step S1201: No), VPN policy information 203 is read out by the policy management unit 220 (step S1206). By the packet receiving unit 250, the prefix distribution form request message is received from the VPN apparatus 100 of the other party of connection which is an inferior node (step S1207).

The received prefix distribution form request message includes a prefix distribution form which can be used or is desired by the VPN apparatus 100 of the other party of connection as described with step S1203, and therefore by the prefix processing unit 212, the prefix distribution form specified in the prefix distribution form request message is compared with the prefix distribution form which is registered in the total setting of VPN policy information 203 and the connection setting identified by the address of the other party of connection (access source address), and can be used or is desired by the self apparatus 100 (step S1208).

Whether or not a prefix distribution form capable of being used by both VPN apparatuses exists as a result of the comparison is checked by the prefix processing unit 212 (step S1209). If a prefix distribution form capable of being used by both VPN apparatuses exists (step S1209: Yes), a response message including the prefix distribution form capable of being used by both VPN apparatuses is generated by the prefix processing unit 212 (step S1210), and the generated response message is sent to the VPN apparatus 100 of the other party of connection which is an inferior node, by the packet sending unit 260 (step S1211).

If a prefix distribution form capable of being used by both VPN apparatuses does not exist at step S1209 (step S1209: No), the prefix processing unit 212 generates a prefix negotiation error message (step S1212), and such an error message is sent to the VPN apparatus 100 of the other party of connection by the packet sending unit 260 (step S1213).

In this way, a prefix distribution form message (prefix distribution form request message and its response message) is sent and received between both VPN apparatuses 100, whereby a prefix distribution form is negotiated and determined.

Prefix acquirement processing in step S621 in total processing of determining a prefix will now be described. First, the prefix processing unit 212 determines the contents of the determined prefix acquirement method. Prefix acquirement processing (local pool) is performed if the prefix acquirement method is “local pool,” prefix acquirement processing (ISP) is performed if the processing acquirement method is “ISP,” prefix acquirement processing (IPv6 ULA) is performed if the prefix acquirement method is “Unique Local IPv6 Unicast Address,” and prefix acquirement processing (random) is performed if the prefix processing acquirement method is “random.” Each prefix acquirement processing will be described below.

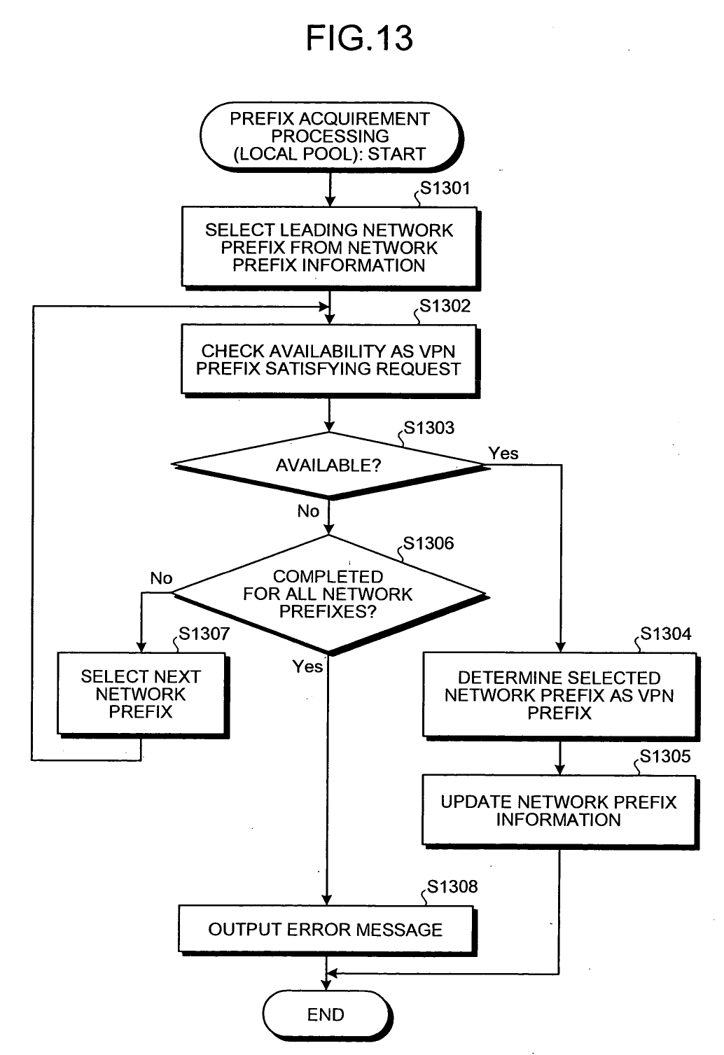

FIG. 13 is a flowchart showing a procedure of prefix acquirement processing (local pool). First, if the determined prefix acquirement method is “local pool,” the prefix processing unit 212 selects a leading network prefix is selected from network prefix information 202 stored in the storage unit 200 (step S1301). Availability of the selected network prefix as a VPN prefix satisfying a request determined by prefix acquirement method determination processing is checked (step S1302), and whether or not the network prefix is available is determined (step S1303).

If it is determined that the selected network prefix is available as a VPN prefix satisfying the request determined by prefix acquirement method determination processing (step S1303: Yes), the prefix processing unit 212 determines the selected network prefix as a VPN prefix (step S1304). Then, by the prefix processing unit 212, the VPN-ID of VPN connection with the VPN apparatus 100 of the other party of connection is registered in the VPN-ID field, “in-use” is registered in the in-use field, and the contents determined by prefix distribution method determination processing and prefix distribution form determination processing are registered in the distribution method field and the distribution form filed, respectively, for the selected network prefix in network prefix information 202, whereby network prefix information 202 is updated (step S1305).

If it is determined at step S1303 that the selected network prefix is unavailable as a VPN prefix satisfying the request determined by prefix acquirement method determination processing (step S1303: No), the prefix processing unit 212 determines whether or not selection has been done for all network prefixes registered in network prefix information 202 (step S1306). If there is some unselected network prefix (step S1306: No), the prefix processing unit 212 selects a next network prefix in network prefix information 202 (step S1307), and repeatedly performs processing in steps S1302 and S1303.

If it is determined at step S1306 that selection has been completed for all network prefixes in network prefix information 202 (step S1306: Yes), the prefix processing unit 212 determines that a network prefix that can be determined as a VPN prefix does not exist, and outputs an error message indicating the result of determination (step S1308).

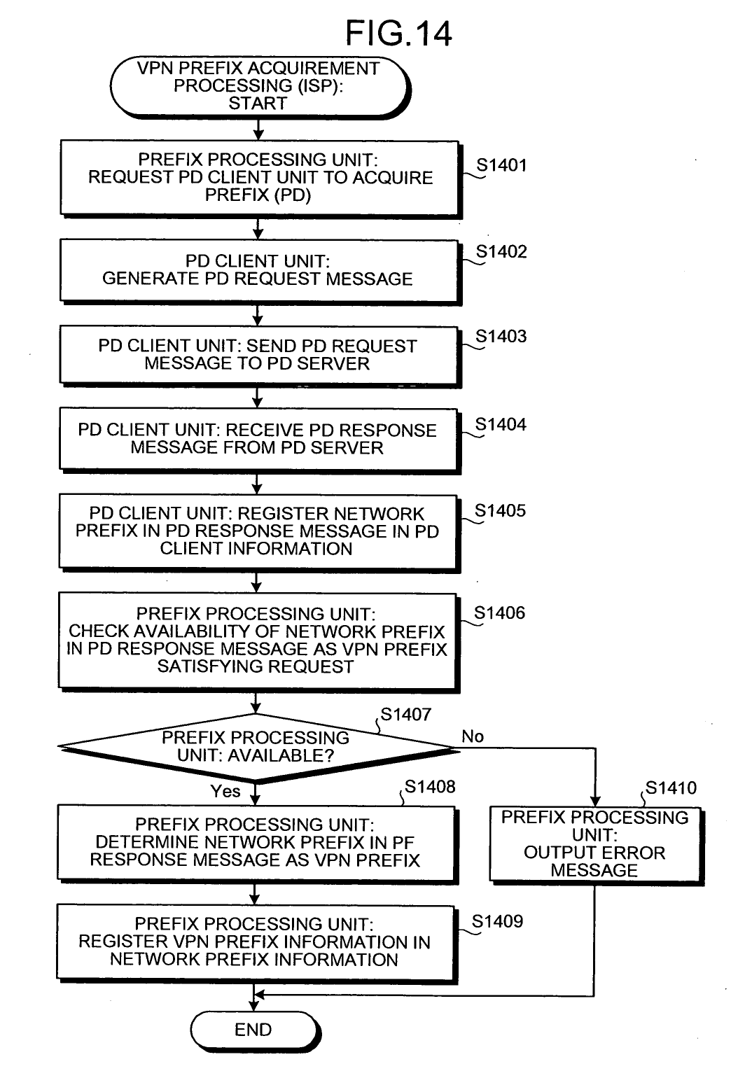

FIG. 14 is a flowchart showing a procedure of prefix acquirement processing (ISP). If the determined prefix acquirement method is “ISP,” the prefix processing unit 212 requests PD client unit 214 to send a prefix acquirement request (PD request) to the PD server 105 (step S1401). The PD client unit 214, which has been requested to do so, generates a prefix acquirement request (PD request) (step S1402), sends the generated PD request to the PD server 105 on the Internet 107 (step S1403), and waits for reception from the PD server 105.

When a PD response to the PD request is sent from the PD server 105, the PD client unit 214 receives the PD response via the packet receiving unit 250 (step S1404). Generation of the PD request and send/receive of the PD request and the PD response with the PD server 105 is performed according to a corresponding protocol by the PD client unit 214.

Next, the PD client unit 214 extracts a network prefix from the received PD response, and registers this network prefix in PD client information 213 of the storage unit 200 (step S1405).

Next, the prefix processing unit 212 determines availability of the network prefix in PD response as a VPN prefix satisfying a request (step S1406). If it is determined that the network prefix is available (step S1407: Yes), the prefix processing unit 212 determines the network prefix in PD response as the VPN prefix (step S1408).

Then, the prefix processing unit 212 adds the determined network prefix of the VPN prefix to network prefixes. The VPN-ID of VPN connection with the VPN apparatus 100 of the other party of connection is registered in the VPN-ID field for the added network prefix, “in-use” is registered in the in-use field, and the contents determined by prefix distribution method determination processing and prefix distribution form determination processing are registered in the distribution method field and the distribution form field, respectively, whereby the determined VPN prefix is registered in network prefix information 202 (step S1409).

If it is determined at step S1407 that the network prefix in PD response is unavailable as a VPN prefix (step S1407: No), the prefix processing unit 212 outputs an error message indicating the result of determination (step S1410) to complete processing.

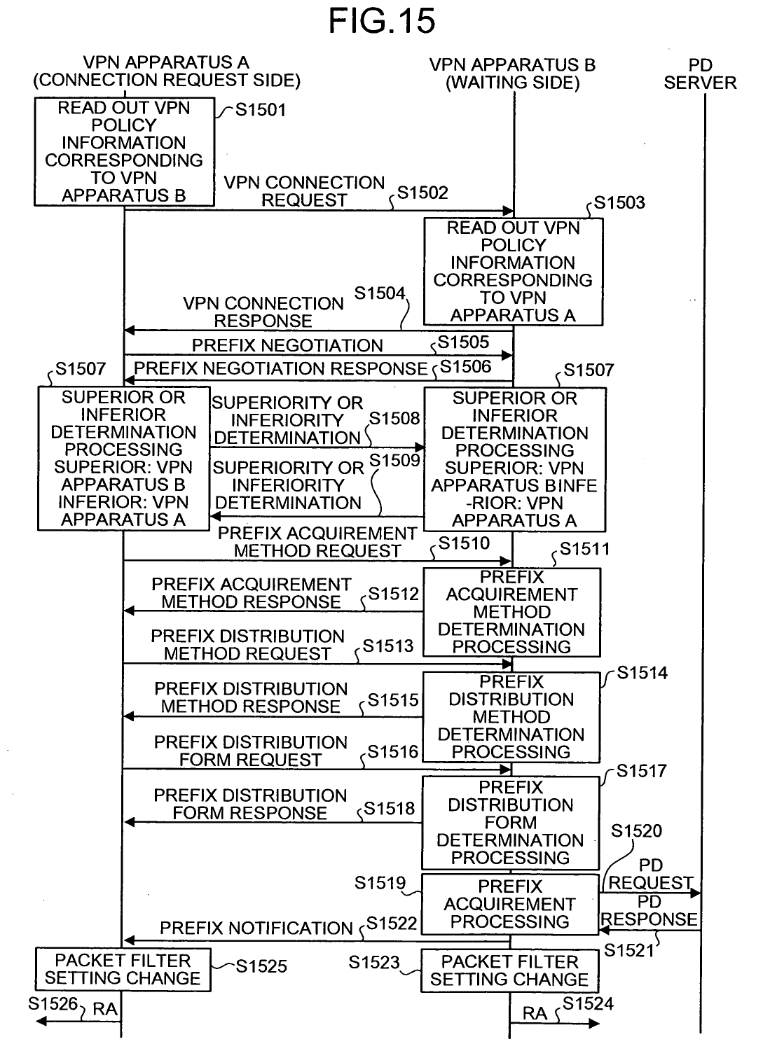

FIG. 15 is a sequence diagram showing an exchange of a message sent and received between VPN apparatuses 100c and 100d having a router function in prefix determination processing where it is determined that the prefix acquirement method is “ISP.” Here, the VPN apparatus making a VPN connection request is VPN apparatus A and the VPN apparatus waiting for VPN connection is VPN apparatus B.

The processing and flow from the reading of VPN policy information 203 corresponding to the VPN apparatus B by the VPN apparatus A to the determination of a prefix distribution form and the sending of a response message of the prefix distribution form by the VPN apparatus B (steps S1501 to S1518) is the same as the processing and flow described with FIG. 7 (steps S701 to S718). In the example of FIG. 15, the prefix acquirement method is “ISP,” “RA notification” is determined as the prefix distribution method, and “individual” is determined as the prefix distribution form.

When response message to a prefix distribution form request determined by prefix distribution form determination processing (step S1517) is sent to the VPN apparatus A of the inferior node (step S1518), then prefix acquirement processing is performed by the prefix processing unit 212 of the VPN apparatus B to determine a VPN prefix (step S1519). Here, if the prefix acquirement form is “local pool,” the prefix processing unit 2712 requests the PD client unit 214 to make a prefix acquirement request to the PD server 105, and the PD client unit 2714 requested to do so sends a prefix acquirement request (PD request) to the PD server 2601 of the network of the ISP 102 (step S1520). When a PD response specifying a network prefix is sent from the PD server 105 (step S1521), then such a PD response is received, and the network prefix specified in the PD response is determined as a VPN prefix, and stored in PD client information 213. A prefix notification message specifying the VPN prefix is sent to the VPN apparatus A (step S1522). Subsequent processing (steps S1523 to S1526) is performed in the same manner as in processing in steps S721 to S724 described with FIG. 7.

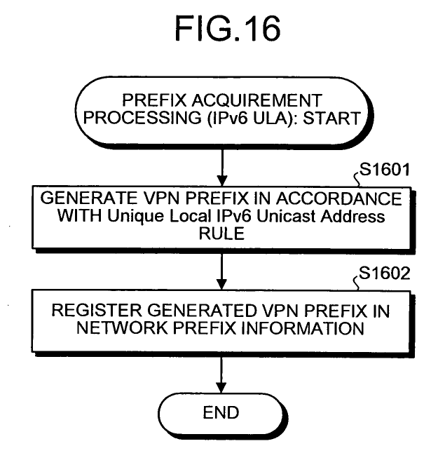

FIG. 16 is a flowchart showing a procedure of prefix acquirement processing (IPv6 ULA). If the determined prefix acquirement method is “Unique Local IPv6 Unicast Address,” the prefix processing unit 212 generates an address corresponding to a VPN prefix in accordance with the rule of Unique Local IPv6 Unicast Address specified in IPv6 (step S1601).

The prefix processing unit 212 adds the generated address of the VPN prefix to the prefix field of network prefix information 202. The VPN-ID of VPN connection with the VPN apparatus 100 of the other party of connection is registered in the VPN-ID field for the added prefix, “in-use” is registered in the in-use field, and the contents determined by prefix distribution method determination processing and prefix distribution form determination processing are registered in the distribution method field and the distribution form field, respectively, whereby the determined VPN prefix is registered in network prefix information 202 (step S1602).

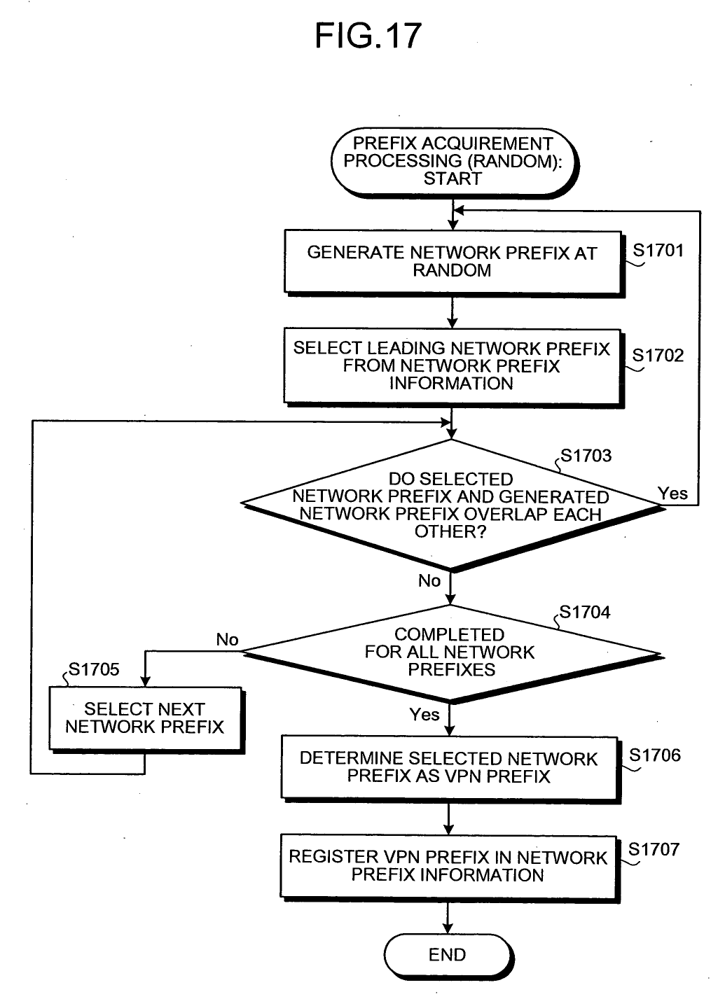

FIG. 17 is a flowchart showing a procedure of prefix acquirement processing (random). If the determined prefix acquirement method is “random,” the prefix processing unit 212 first generates a network prefix at random (step S1701).

Then, the prefix processing unit 212 selects a leading network prefix from network prefix information 202 stored in the storage unit 200 (step S1702). Whether or not the network prefix selected from network prefix information 202 and the network prefix generated at random at step S1701 overlap each other is checked (step S1703). If they overlap each other (step S1703: Yes), processing returns to step S1701 to generate a network prefix at random again.

If the network prefix selected from network prefix information 202 and the network prefix generated at random at step S1701 does not overlap each other at step S1703 (step S1703: No), the prefix processing unit 212 determines whether or not selection has been done for all network prefixes registered in network prefix information 202 (step S1704). If there is some unselected network prefix (step S1704: No), the prefix processing unit 212 selects a next network prefix in network prefix information 202 (step S1705), and repeatedly performs processing in step S1703.

If it is determined at step S1704 that selection has been completed for all network prefixes in network prefix information 202 (step S1704: Yes), the prefix processing unit 212 determines the network prefix selected at step S1702 as a VPN prefix (step S1706).

Then, the prefix processing unit 212 adds the determined network prefix of the VPN prefix to network prefix information 202. The VPN-ID of VPN connection with the VPN apparatus 100 of the other party of connection is registered in the VPN-ID field for the added network prefix, “in-use” is registered in the in-use field, and the contents determined by prefix distribution method determination processing and prefix distribution form determination processing are registered in the distribution method field and the distribution form field, respectively, whereby the determined VPN prefix is registered in network prefix information 202 (step S1707).

By prefix acquirement processing for each prefix acquirement method by the prefix processing unit 212 described above, the VPN prefix is determined.

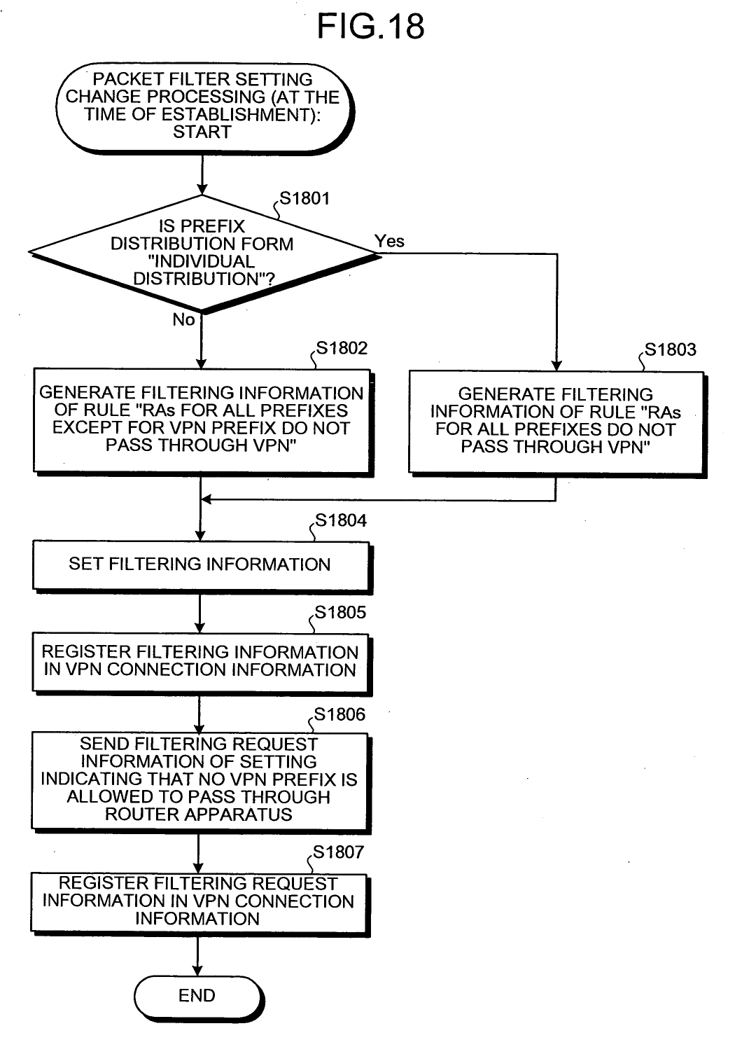

Packet filter setting change processing in step S625 in total processing of determining a prefix will now be described. FIG. 18 is a flowchart showing a procedure of packet filter setting change processing performed at the time of establishment of VPN connection.

First, the packet filter unit 231 checks whether or not the prefix distribution form determined by prefix distribution form determination processing is “individual” distribution (step S1801). If the determined prefix distribution form is not “individual” distribution, namely it is “collective” distribution (step S1801: No), filtering information of a rule providing that “RAs for all network prefixes except for the VPN prefix do not pass through the VPN” is generated (step S1802).

If it is determined at step S1801 that the determined prefix distribution form is “individual” distribution (step S1801: Yes), filtering information of a rule providing that “RAs for all network prefixes do not pass through the VPN” is generated (step S1803).

Then, filtering information generated at step S1802 or S1803 is set in the packet filter unit (step S1804), and the packet filter unit 231 registers this filtering information in the “filtering information” field of a VPN-ID corresponding to VPN connection with the VPN apparatus 100 of the other party of connection in VPN connection information 203 (step S1805).

Next, The packet filter unit 231 sends filtering request information of contents of setting providing that the VPN prefix is not allowed to pass to the router apparatus 101 via the packet sending unit 260 (step S1806). The packet filter unit 231 registers this filtering request information in the “filtering request information” field of a VPN-ID corresponding to VPN connection with the VPN apparatus 100 of the other party of connection in VPN connection information 203 (step S1807). By processing described above, packet filtering based on the determined VPN prefix is performed.

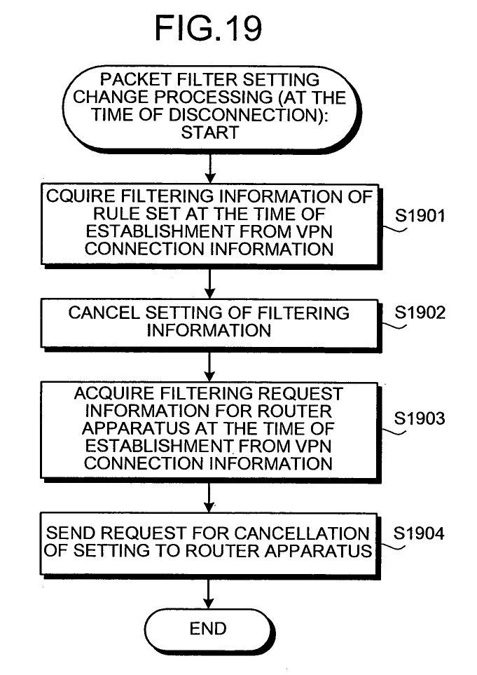

Packet filter setting change processing at the time of disconnection of VPN connection will now be described. FIG. 19 is a flowchart showing a procedure of packet filter setting change processing performed at the time of disconnection of VPN connection.

First, the packet filter unit 231 acquires filtering information of the rule set at step S1805 from VPN connection information 203 in packet filter setting change processing at the time of establishment of VPN connection (step S1901). The setting of filtering information acquired by the packet filter unit 231 is cancelled (step S1902).

Next, the packet filter unit 231 acquires filtering request information for the router apparatus 101 set at step S1807 from VPN connection information 203 in packet filter setting change processing at the time of establishment of VPN connection (step S1903),. A request for cancellation of the setting of the acquired filtering request information is sent to the router apparatus 101 (step S1904). By such processing, the packet filter setting changed at the time of establishment of VPN connection is cancelled.

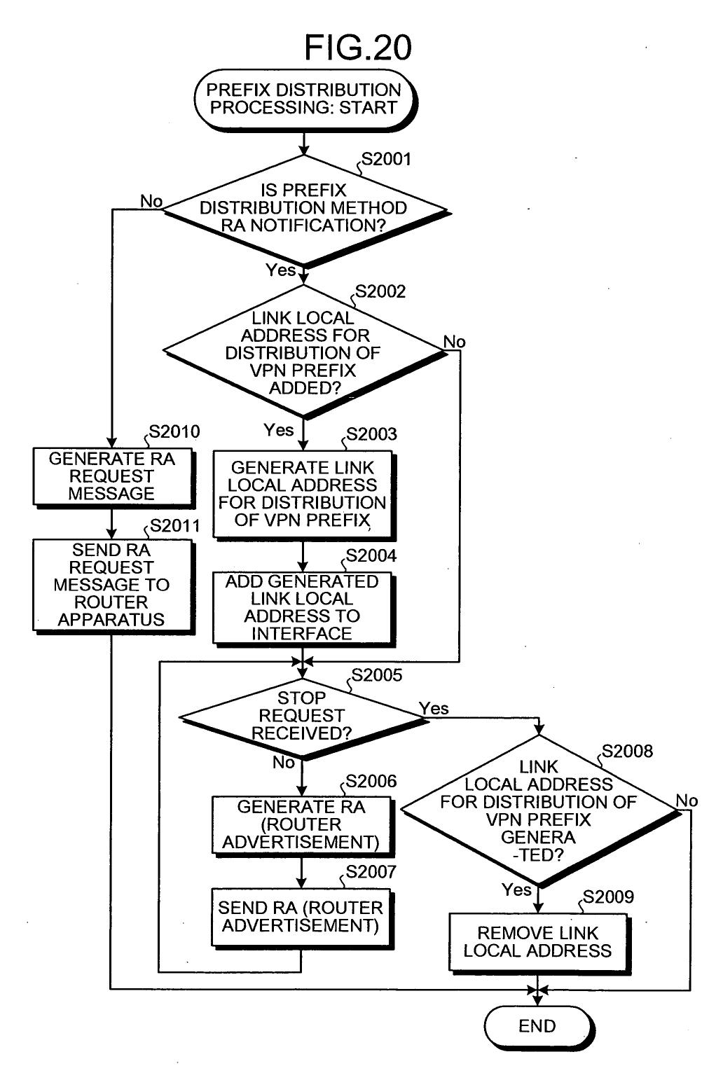

Prefix distribution processing in step S625 in total processing of determining a prefix will now be described. FIG. 20 is a flowchart showing a procedure of prefix distribution processing. First, the router advertisement processing unit 240 checks whether or not the prefix distribution method determined by prefix distribution method determination processing by the prefix processing unit 212 is “RA notification” (step S2001).

If the determined prefix distribution method is “RA notification” (step S2001: Yes), the router advertisement processing unit 240 determines whether or not a setting for assigning a link local address for distribution of a VPN prefix has been made (step S2002). If a setting for assigning a link local address for distribution of a VPN prefix has been made (step S2002: Yes), the router advertisement processing unit 240 generates a link local address for distribution of a VPN prefix (step S2003), and assigns the generated link local address to the network interface 270 (step S2004).

If it is determined at step S2002 that a setting for assigning a link local address for distribution of a VPN prefix has not been made (step S2002: No), generation and assignment of such a link local address is not performed.

The router advertisement processing unit 240 repeats processing of generating an RA specifying a VPN prefix (step S2006) and sending the generated RA into the network 104 managed by the self VPN apparatus 100 (step S2007) until it receives a request for the stop of distribution of a prefix by disconnection of VPN connection or the like (step S2005: No). In this way, the determined VPN prefix is distributed into the network 104.

If a request for the stop of distribution of a prefix by disconnection of VPN connection or the like has been received at step S2005 (step S2005: Yes), the router advertisement processing unit 240 determines whether or not a link local address for distribution of a VPN prefix has been generated (step S2008), and if it has been generated (step S2008: Yes), the link local address is removed (step S2009) to complete processing.

Processing returns to step S2001, and if the prefix distribution method determined by prefix distribution method determination processing is not “RA notification, namely it is “RA request” (step S2001: No), the router advertisement processing unit 240 generates an RA request message specifying a VPN prefix (step S2010). In this RA request message, not only the VPN prefix to be notified but also the prefix length, the expiration date of the prefix, and notification states such as the start of notification and the stop of notification or the update of information are specified.

The router advertisement processing unit 240 sends the generated RA request message via the packet sending unit 260 to the router apparatus 101 in the network 104 managed by the self VPN apparatus 100 (step S2011). In this way, an RA is sent into the network 104 by the router apparatus 101 which has received the RA request message, and the VPN prefix is distributed into the network 104.

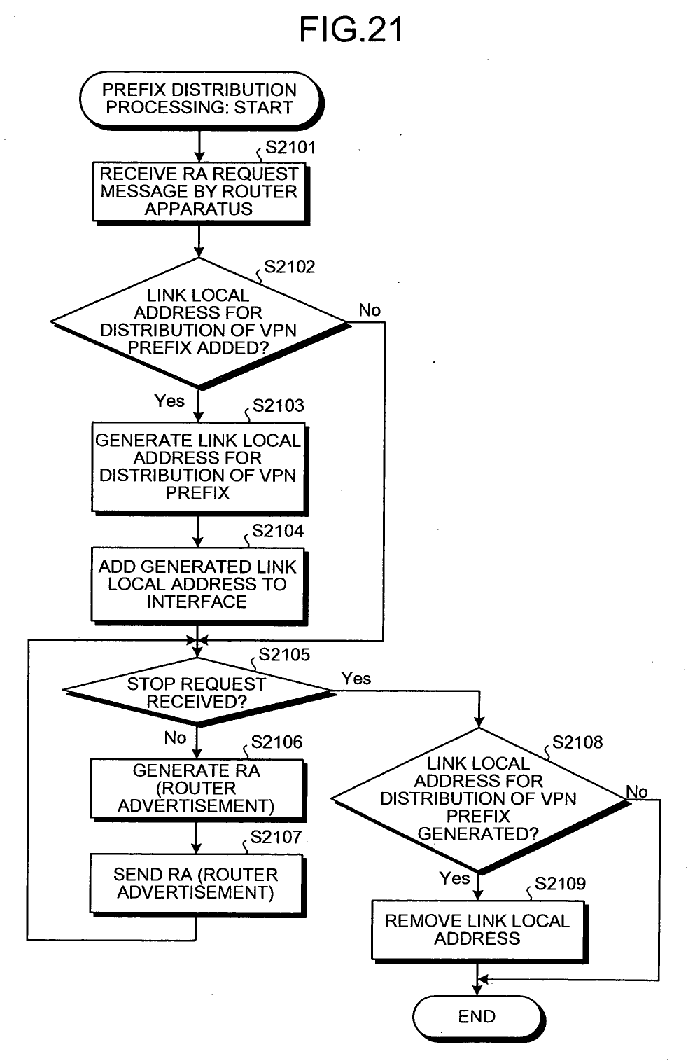

Prefix distribution processing by the router apparatus 101 which has received the RA request message from the VPN apparatus 100 will now be described. FIG. 21 is a flowchart showing a procedure of prefix distribution processing by the router apparatus 101.

The router apparatus 101 receives the RA request message from the VPN apparatus 100 (step S2101), and then determines whether or not a setting for assigning a link load address for distribution of a VPN prefix has been made (step S2102). If a setting for assigning a link load address for distribution of a VPN prefix has been made (step S2102: Yes), the router apparatus 101 generates a link load address for distribution of a VPN prefix (step S2103), and assigns the generated link load address to the network interface (step S2104).

If it is determined at step S2102 that a setting for assigning a link load address for distribution of a VPN prefix has not been made (step S2102: No), generation and assignment of such a link local address is not performed.

The router apparatus 101 repeats processing of generating an RA specifying a VPN prefix (step S2106) and sending the generated RA into the network 104 managed by the self VPN apparatus 100 (step S2107) until it receives a request for the stop of distribution of a prefix by disconnection of VPN connection or the like (step S2105: No). In this way, the determined VPN prefix is distributed into the network 104. It is preferable that when the RA is generated, the field of Router lifetime of the RA to is set to “0”, so that the router is not considered as a default router.

If a request for the stop of distribution of a prefix by disconnection of VPN connection or the like has been received at step S2105 (step S2105: Yes), the router apparatus 101 determines whether or not a link local address for distribution of a VPN prefix has been generated (step S2108), and if it has been generated (step S2108: Yes), the link local address is removed (step S2109) to complete processing.

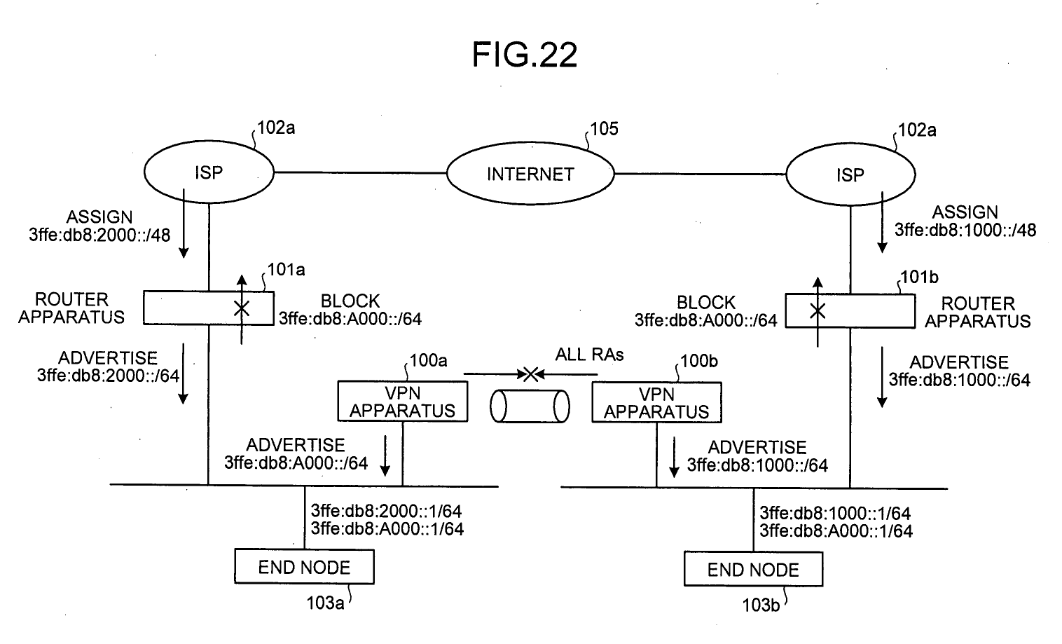

FIG. 22 is an explanatory view showing packet filtering and the state of sending of an RA where it is determined that the prefix distribution method is “RA notification” and the prefix distribution form is “individual.”

In FIG. 22, the VPN prefix is determined to be “3ffe:db8:A000::/64”, and the VPN prefix is distributed to each network with the RA individually for the VPN apparatus 100a and the VPN apparatus 100b. The packet filter setting is made so that all RAs are blocked between the network of the VPN apparatus 100a and the network of the VPN apparatus 100b.

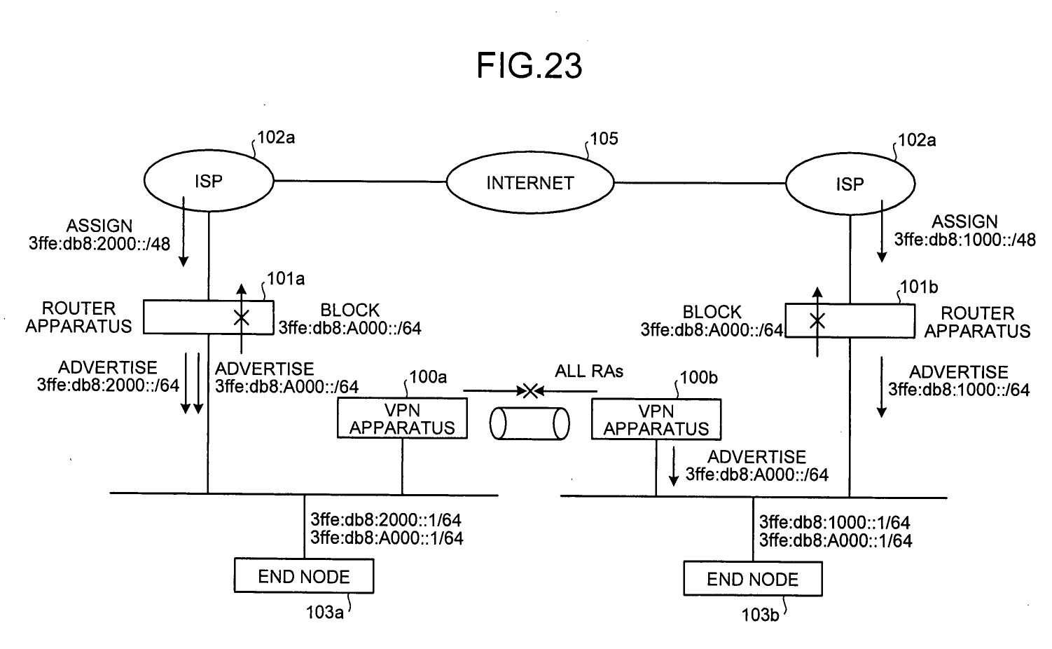

FIG. 23 is an explanatory view showing packet filtering and the state of sending of an RA where “RA notification” and “RA request” exist for the prefix distribution method, and the prefix distribution form is determined to be “individual.” FIG. 23 shows an example in which the prefix distribution method is determined to be “RA request” for the VPN apparatus 1D0a and the prefix distribution method is determined to be “RA notification” for the VPN apparatus 100b.

In FIG. 23, the VPN prefix is determined to be “3ffe:db8:A000::/64”, and the VPN prefix is distributed to each network with the RA individually for the router apparatus 101a of the network of the VPN apparatus 100a and the VPN apparatus 100b. The packet filter setting is made so that all RAs are blocked between the network of the VPN apparatus 100a and the network of the VPN apparatus 100b.

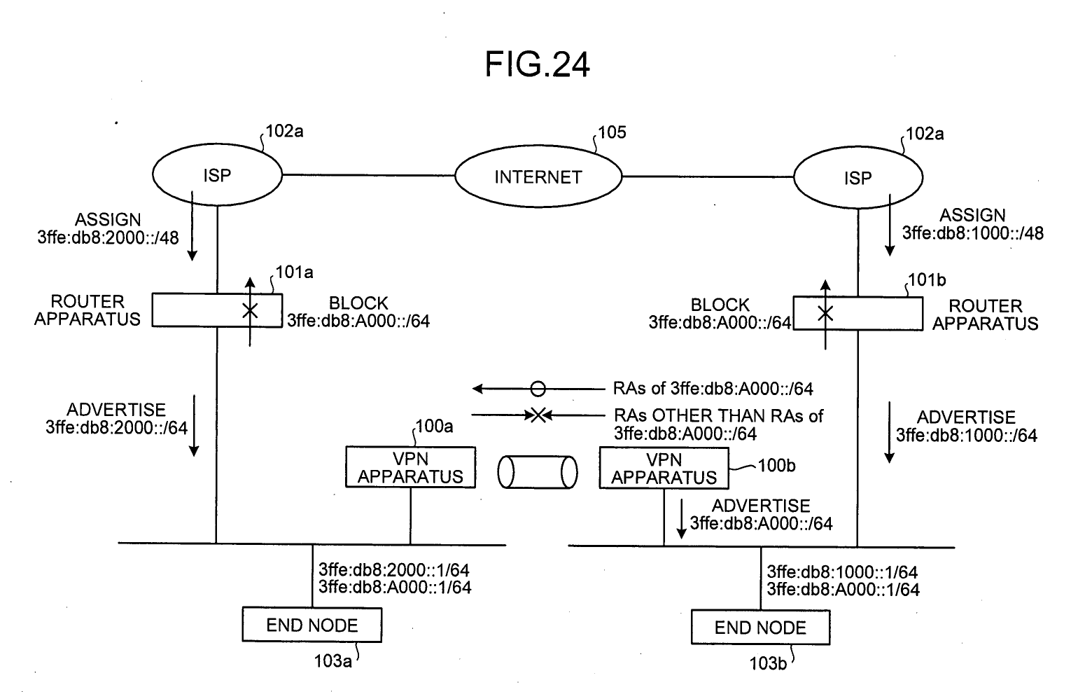

FIG. 24 is an explanatory view showing packet filtering and the state of sending of an RA where it is determined that the prefix distribution method is “RA notification” and the prefix distribution form is “collective.”

In FIG. 24, the VPN prefix is determined to be “3ffe:db8:A000::/64”, and the RA sending node is the VPN apparatus 100b. The VPN prefix is collectively distributed into two VPN-connected networks with the RA from the VPN apparatus 100b which is the RA sending node. The packet filter setting is made so that all RAs except for the VPN prefix “3ffe:db8:A000::/64” are blocked between the network of the VPN apparatus 100a and the network of the VPN apparatus 100b.

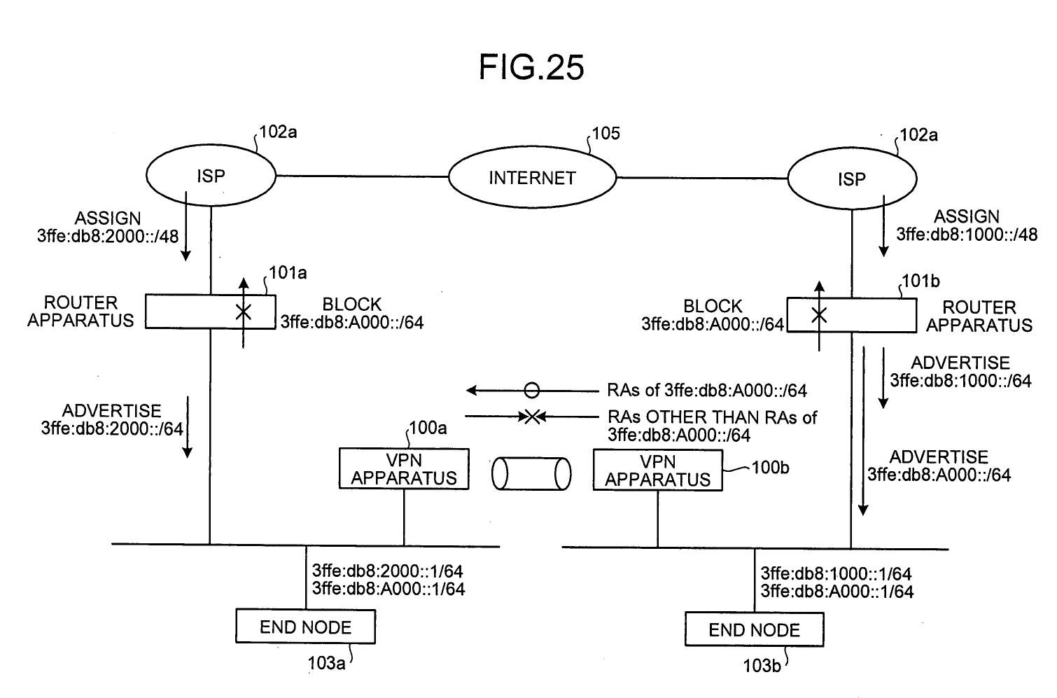

FIG. 25 is an explanatory view showing packet filtering and the state of sending of an RA where it is determined that the prefix distribution method is “RA request” and the prefix distribution form is “collective.”

In FIG. 25, the VPN prefix is determined to be “3ffe:db8:A000::/64”, and the RA sending node is the VPN apparatus 100b. The VPN prefix is collectively distributed into VPN-connected two networks with the RA from the router apparatus 101b according to a request from the VPN apparatus 100b which is the RA sending node. The packet filter setting is made so that all RAs except for the VPN prefix “3ffe:db8:A000::/64” are blocked between the network of the VPN apparatus 100a and the network of the VPN apparatus 100b.

In the above-mentioned FIGS. 22 to 25, network prefixes for traffics other than the VPN are assigned “3ffe:db8:2000::/64” in the network of the router apparatus 101a, and network prefixes for traffics other than the VPN are assigned “3ffe:db8:1000::/64” in the network of the router apparatus 101b, and the VPN prefix “3ffe:db8:A000::/64” for use in communication by the VPN is differentiated from such a network prefix, and therefore the VPN traffic and traffics other than the VPN can be separated based on the network prefix between VPN-connected networks.

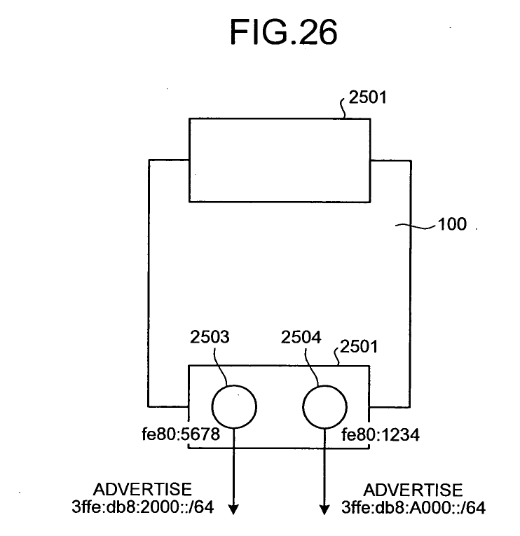

In any case, the VPN apparatuses 100a and 100b or the router-apparatuses 101a and 101b distribute a single VPN network prefix into the network with the RA, but two VPN prefixes may be determined between VPN apparatuses and distributed as shown in FIG. 26.

Thus, in the VPN apparatus 100 according to this embodiment, the VPN prefix which is a network prefix for use in communication by the VPN is determined through negotiation between VPN apparatuses to be VPN-connected including its acquirement method, distribution method and distribution form, and the packet filter setting is changed based on the VPN prefix, and the VPN prefix is distributed into each VPN-connected network of the VPN prefix, and therefore the VPN traffic and traffics other than the VPN can be separated based on the VPN prefix between VPN-connected networks.

In the VPN apparatus 2600 according to the first embodiment, the network prefix is acquired from the PD server 2.601 when the prefix acquirement method is “ISP,” but a prefix acquirement request may be sent to the above-mentioned VPN intermediate server 106 on the Internet 107 to determine the VPN prefix from the network prefix specified in its response message.

The VPN apparatus according to a second embodiment will now be described.

In the VPN apparatus 100 according to the first embodiment, a VPN prefix is selected from network prefix information managed in the VPN apparatus 100 and is determined if the prefix acquirement method is determined to be “local pool,” but in the VPN apparatus 100 according to the second embodiment, a PD request is regularly made, and a network prefix acquired from a PD response each time the request is made is stored in PD client information 2713, and if the prefix acquirement method is determined to be “local pool”, a network prefix is acquired from PD client information 213 and determined as a VPN prefix.

The network configuration of the network system of this embodiment is the same as the network configuration of the first embodiment.

The VPN for use in this embodiment is Layer 2VPN as in the first embodiment, and has the form of the site-to-site VPN in which a plurality of networks 104a to 104d are connected.

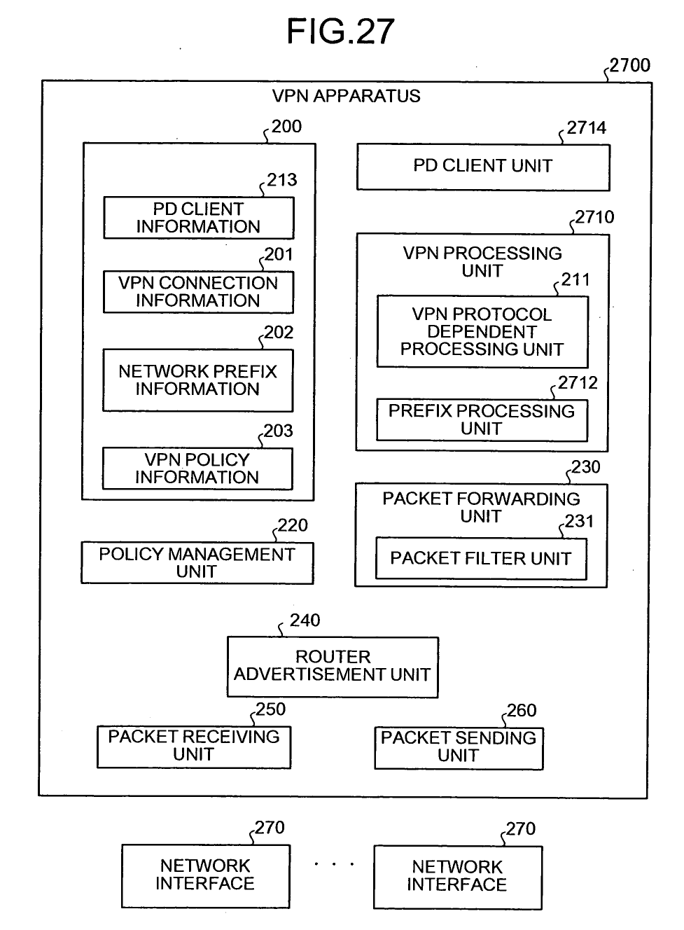

FIG. 27 is a block diagram showing a functional configuration of the VPN apparatus 2700. As shown in FIG. 27, the VPN apparatus 2700 comprises principally a PD client unit 2714, a VPN processing unit 2710, a policy management 220, a packet forwarding unit 230, a router advertisement processing 240, a packet receiving unit 250, a packet sending unit 260, a storage unit 200 and a plurality of network interfaces 270.

The VPN processing unit 2710 manipulates VPN connection information 201 stored in the storage unit 200, and performs processing compliant with the VPN protocol, such as establishment and disconnection of the VPN. The VPN processing unit 2710 comprises a VPN protocol dependent processing unit 211 and a prefix processing unit 2712. The function of the VPN protocol dependent processing unit 211 is the same as that of the VPN apparatus 100 of the first embodiment.

The prefix processing unit 2712 performs processing of determining a VPN prefix through negotiation by sending and receiving of a VPN prefix message extracted by the VPN protocol dependent processing unit 211 between the prefix processing unit 2712 and the VPN apparatus 100 of the other party of connection at the time of processing of establishment of VPN connection as in the first embodiment. In this embodiment, a network prefix is acquired from PD client information 213 stored in the storage unit 200 if the prefix acquirement method is “local pool” in prefix acquirement processing.

The PD client unit 2714 performs of sending a request for acquirement of a network prefix to the PD server 105 present on the network side of the ISP 102 regularly at fixed time intervals and registering the network prefix received from the PD server 105 in PD client information 213 of the storage unit 200.

The policy management unit 220, the packet forwarding unit 230, the router advertisement processing unit 240, the packet receiving unit 250, the packet sending unit 260, the storage unit 200 and the plurality of network interfaces 270 have the same configurations and functions as those of the first embodiment.

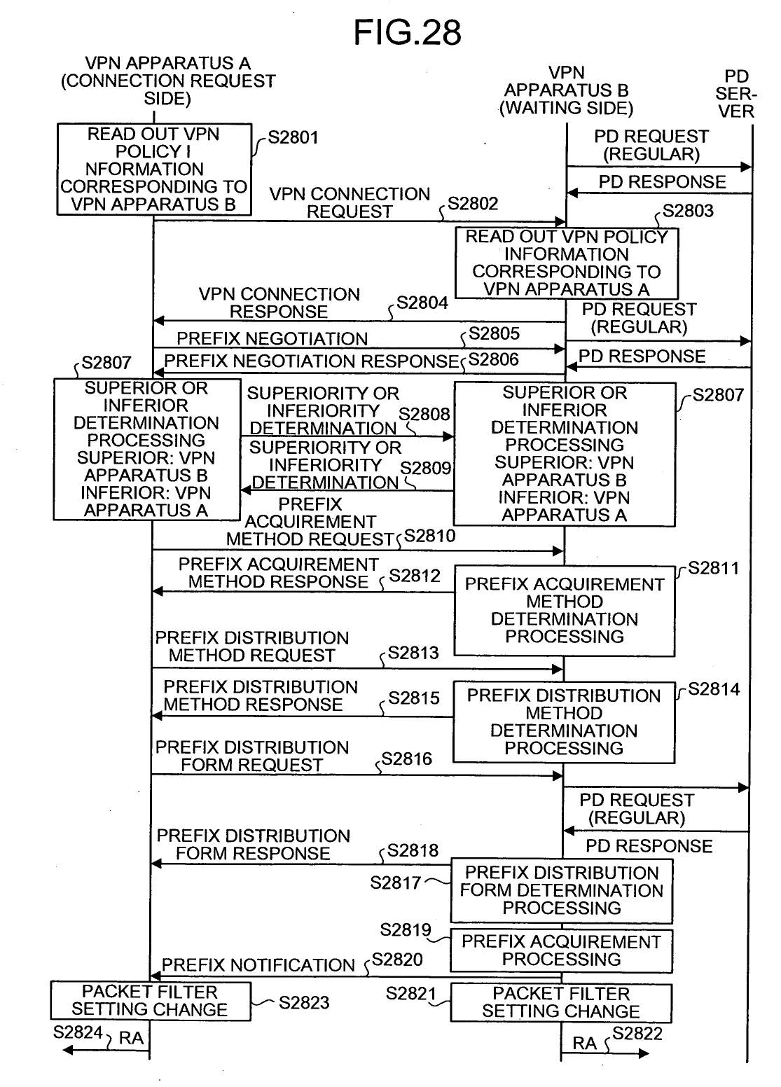

FIG. 28 is a sequence diagram showing an exchange of a message sent and received in prefix determination processing between VPN apparatuses 2700 having a router function in the second embodiment. Here, the VPN apparatus making a VPN connection request is VPN apparatus A, and the VPN apparatus waiting for VPN connection is VPN apparatus B.

The PD client unit 2714 of the VPN apparatus B sends a PD request to the PD server 2601 regularly at fixed time intervals and receives a PD response as shown in FIG. 28. The PD client unit 2714 stores the network prefix in PD response in PD client information 213 on every occasion.

The processing and flow from the readout of VPN policy information 203 corresponding to the VPN apparatus B by the VPN apparatus A to the determination of a prefix distribution form and the sending of a response message of the prefix distribution form by the VPN apparatus B (steps S2801 to S2818) are the same as the processing and flow of the first embodiment described in FIG. 7 (steps S701 to S718). In the example of FIG. 28, “local pool” is determined as the prefix acquirement method, “RA notification” is determined as the prefix distribution method, and “individual” is determined as the prefix distribution form.

A response message to a prefix distribution form request determined by prefix distribution form determination processing (step S2817) is sent to the VPN apparatus A of the inferior node (step S2818), and then prefix acquirement processing is performed by the prefix processing unit 2712 of the VPN apparatus B to determine a VPN prefix (step S2819). At this time, the prefix processing unit 2712 retrieves and acquires a network prefix from PD client information 213, and determines the network prefix as the VPN prefix.

A prefix notification message specifying this VPN prefix is sent to the VPN apparatus A (step S2820). Subsequent processing (steps S2821 to S2824) is performed in the same manner as in processing in steps S721 to S724 of the first embodiment in FIG. 7.

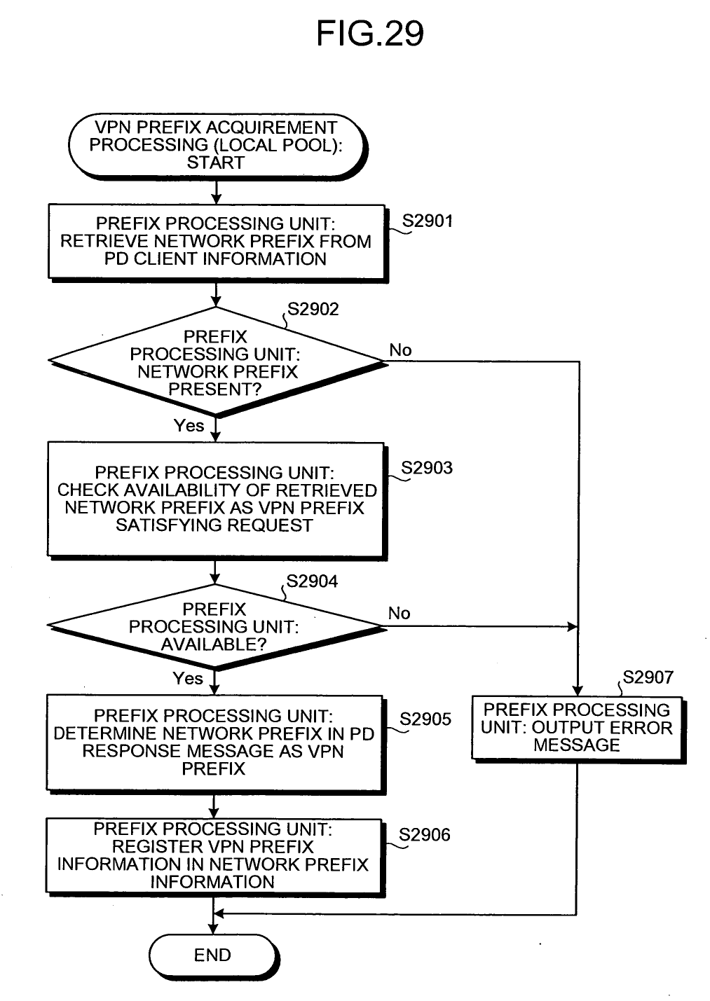

Prefix acquirement processing in step S2819 where the prefix acquirement method is “local pool” will now be described. FIG. 29 is a flowchart showing a procedure of prefix acquirement processing (local pool) by the VPN apparatus 2700 according to the second embodiment.

If the prefix acquirement method is “local pool,” the prefix processing unit 2712 retrieves from PD client information 213 the network prefix acquired regularly from the PD server 2601 by the PD client unit 2714 (step S2901).

The prefix processing unit 2712 checks whether or not the network prefix exists in PD client information 213 (step S2902). If it exists (step S2902: Yes), the prefix processing unit 2712 checks availability of the network prefix in PD response as a VPN prefix satisfying a request (step S2903). If it is determined that the network prefix is available (step S2904: Yes), the prefix processing unit 2712 determines the retrieved network prefix as a VPN prefix (step S2905).

Then, the prefix processing unit 2712 adds the network prefix of the determined VPN prefix to network prefixes. The VPN-ID of VPN connection with the VPN apparatus 2700 of the other party of connection is-registered in the VPN-ID field for the added network prefix, “in-use” is registered in the in-use field, and the contents determined by prefix distribution method determination processing and prefix distribution form determination processing are registered in the distribution method field and the distribution form field, respectively, whereby the determined VPN prefix is registered in network prefix information 202 (step S2906).

If it is determined at step S2902 that the network prefix does not exist in PD client information 213 (step S2902: No) and it is determined at step S3104 that the retrieved network prefix is unavailable as a VPN prefix (step S2904: No), the prefix processing unit 2712 outputs an error massage indicating the result of determination for each case (step S2907) to complete processing.

Thus, in the VPN apparatus 2700 according to the second embodiment, the network prefix is regularly acquired from the PD server 105 and stored in PD client information 213, and PD client information 213 is searched at the time of prefix acquirement processing to determine a VPN prefix from the existing network prefix, and therefore the VPN prefix can be appropriately determined, and the VPN traffic and traffics other than the VPN can be separated based on the VPN prefix between VPN-connected networks.

The VPN apparatus according to a third embodiment will now be described.

The VPN apparatus according to the first and second embodiments performs superiority or inferiority determination processing through negotiation by the sending and receiving of a superiority or inferiority determination message between VPN-connected VPN apparatuses, but the VPN apparatus according to the third embodiment determines superiority or inferiority without carrying out negotiation by the sending and receiving of the superiority or inferiority determination message.

The configuration of the network system and VPN apparatus according to the third embodiment is similar to that in the first embodiment, and the description thereof is not presented.

The VPN apparatus according to the third embodiment is different from that of the first embodiment in that the prefix processing unit 212 determines superiority or inferiority without carrying out negotiation by the sending and receiving of a superiority or inferiority determination message.

Specifically, the prefix processing unit 212 of this embodiment sends a VPN connection request message including a prefix request message consisting of a network prefix and a prefix length desired to be used in VPN communication to the VPN apparatus 100 of the other party of connection via the packet sending unit 260 in advance. The VPN apparatus 100 of the other party of connection receives a response message including the prefix request message consisting of the network prefix and the prefix length desired to be used in VPN communication via the packet receiving unit 250. The prefix processing unit 212 performs processing of determining superiority or inferiority according to which is larger the self network prefix or the network prefix of the other party of connection. Namely, the VPN apparatus 100 having a larger network prefix is determined to be a superior node, and the VPN apparatus 100 having a smaller network prefix is determined to be an inferior node.

Here the prefix request message is a message for requesting a prefix and a prefix length desired to be used in VPN communication, and is used for exchanging the prefix desired by the VPN apparatus and the prefix length desired by the VPN apparatus.

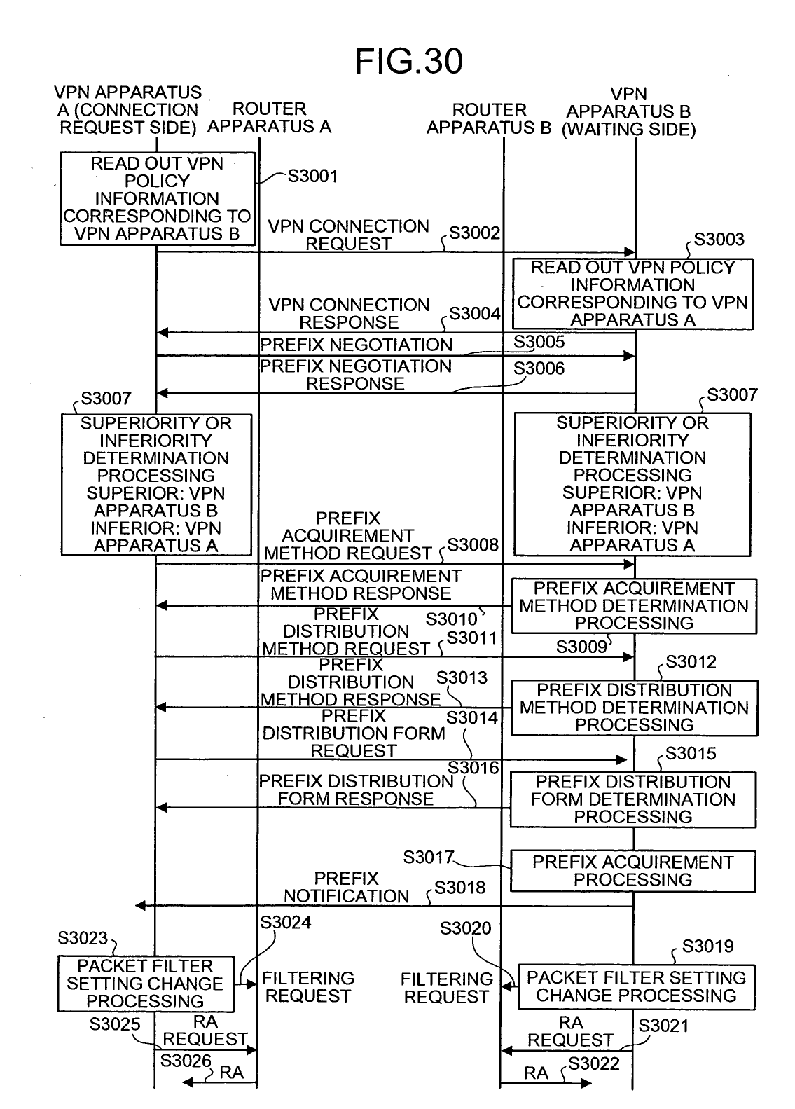

FIG. 30 is a sequence diagram showing an exchange of a message sent and received in prefix determination processing between VPN apparatuses 100a and 100b having no router function according to the third embodiment. Here, the VPN apparatus making a VPN connection request is VPN apparatus A, and the VPN apparatus waiting for the VPN connection request is VPN apparatus B. The router apparatus in the network of the VPN apparatus A is router apparatus A, and the router apparatus in the network of the VPN apparatus B is router apparatus B.

The VPN apparatus A on the connection request side reads out VPN policy information 203 corresponding to the VPN apparatus B being the other party of connection (connection setting of VPN apparatus B) by the policy management unit 220 (step S3001). VPN connection request message including a prefix request message is sent to the VPN apparatus B by the VPN protocol dependent processing unit 211 (step S3002). In the VPN apparatus B, the VPN connection request message is received, and then VPN policy information 203 corresponding to the VPN apparatus A being the other party of connection (connection setting of VPN apparatus A) is read out by the policy management unit 220 (step S3003). Connection processing compliant with the VPN protocol is performed by the VPN protocol dependent processing unit 211, and a VPN connection response message including the prefix request message is sent to the VPN apparatus A (step S3004).

In the VPN apparatus A, a prefix negotiation message is sent to the VPN apparatus B by the prefix processing unit 212 (step S3005), and in the VPN apparatus B which has received the message, whether or not prefix negotiation is possible by the prefix processing unit 212 is determined, and a prefix negotiation response message is sent to the VPN apparatus A as its response (step S3006).

Next, in the VPN apparatus A and the VPN apparatus B, the network prefix acquired by the prefix request message and desired to be used by the other party of connection is compared with the network prefix desired to be used by itself, and superior or inferior is determined by ordering the magnitudes of the network prefixes (step S3007). Namely, negotiation by the sending and receiving of a superiority or inferiority determination message is not carried out, but the VPN apparatus having a larger network prefix is determined to be a superior node, and the VPN apparatus having a smaller network prefix is determined to be an inferior node. In the example of FIG. 30, it is determined that the superior node is the VPN apparatus B and the inferior node is the VPN apparatus A. Subsequent processing (steps S3008 to S3026) is the same as the processing (steps S810 to S828) in the example of FIG. 8 described in the first embodiment.

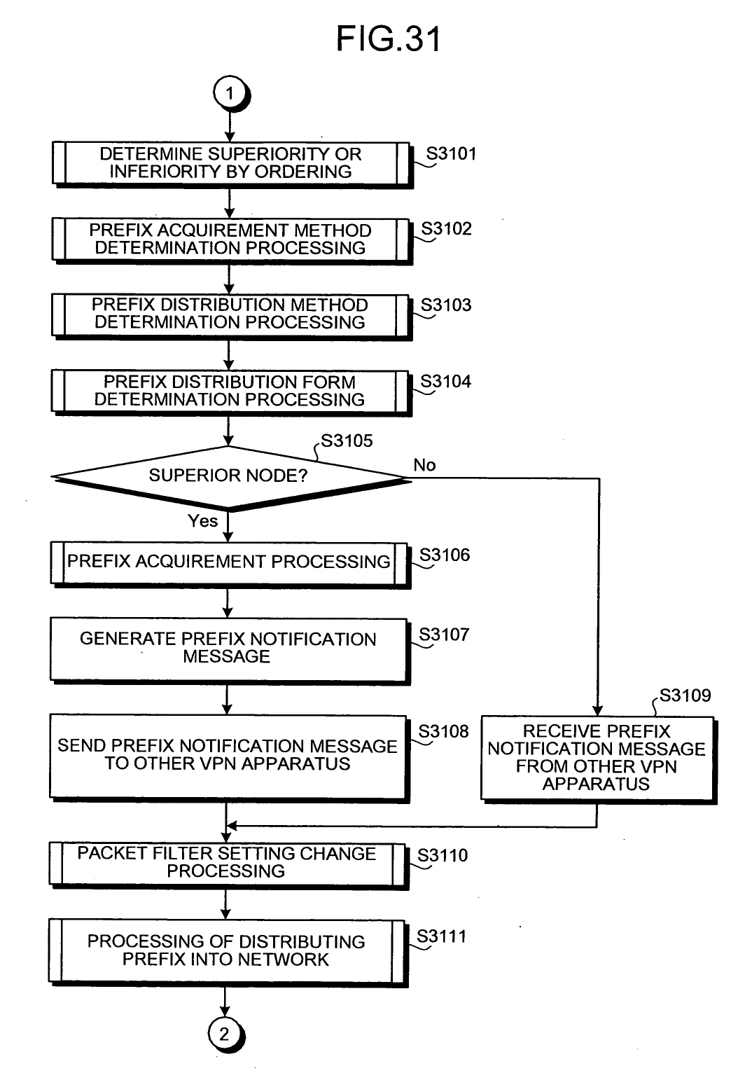

FIG. 31 is a flowchart showing a procedure from determination of superiority or inferiority to prefix distribution processing in total processing of determining a prefix by the VPN apparatus 100 according to the third embodiment. In total processing of determining a prefix, processing from initial setting and policy setting to determination of whether prefix negotiation is possible or not is performed in the same manner as in processing (steps S601 to S615) in FIG. 6A described in the first embodiment. However, the VPN connection request message and the VPN connection request response message are sent with the above-mentioned prefix request message included therein.

If it is determined at step S609 that prefix negotiation is possible in the VPN apparatus 100 on the side of sending the VPN connection request (step S609: Yes), and it is determined at step S615 that prefix negotiation is possible in the VPN apparatus 100 on the side of waiting for the VPN connection request (step S615: Yes), determination of superiority or inferiority for determining a superior node performing processing of determining a VPN prefix and an inferior node receiving a notification of the determined VPN prefix is performed (step S3101). Specifically, as described above, the network prefix acquired by the prefix request message and desired to be used by the other party of connection is compared with the network prefix desired to be used by itself, and superior or inferior is determined by ordering the magnitudes of the network prefixes. Namely, negotiation by the sending and receiving of a superiority or inferiority determination message is not carried out, but the VPN apparatus having a larger network prefix is determined to be a superior node, and the VPN apparatus having a smaller network prefix is determined to be an inferior node.

Subsequent processing (steps S3102 to S3111) is performed in the same manner as in processing (steps S616 to S626) in FIG. 6B described in the first embodiment.

Thus, in the VPN apparatus 100 according to the third embodiment, superiority or inferiority is determined by ordering of the network prefix acquired in advance and desired to be used by the other party of connection and the network prefix desired by itself, and negotiation by the sending and receiving of the superiority or inferiority determination message is not carried out, thus making it possible to efficiently perform prefix determination processing.

In this embodiment, the network prefix and the network prefix length desired by the other party of connection are acquired by the VPN connection request and the prefix request message included in the VPN connection request response message, but negotiation for determination of a prefix distribution method and determination of a prefix distribution form may be omitted by further acquiring a prefix distribution method and a prefix distribution form of the self VPN apparatus 100 from VPN policy information 203 and acquiring a prefix distribution method and a prefix distribution form desired by the VPN apparatus 100 of the other party of connection by the above-mentioned message, and employing the prefix distribution method and the prefix distribution form of the VPN apparatus 100 determined to be a superior bode according to which network prefix is larger. In this case, prefix determination processing can be performed still further efficiently.

The VPN apparatus according to a fourth embodiment will now be described.

The first to third embodiments are based on the premise that VPN apparatuses 100 capable of carrying out negotiation for determination of a prefix are connected to each other, but if the VPN apparatus of the other party of connection does not have a function of carrying out negotiation for determination of a prefix, a response of an error is received when a VPN connection request is sent, thus making it impossible to determine a prefix.

Hence, in the VPN apparatus 100 according to the fourth embodiment, determination of a prefix is made possible even if the VPN apparatus of the other party of connection does not have a function of carrying out negotiation for determination of a prefix.

The configurations of the network system and the VPN apparatus according to the fourth embodiment are the same as those in the first embodiment, and therefore the description thereof is not presented.

In the VPN apparatus according to the fourth embodiment, the prefix processing unit 212 is different from the prefix processing unit of the first embodiment in that if the prefix processing unit 212 sends a VPN connection request message including a prefix negotiation message to the VPN apparatus of the other party of connection and receives a response of an error, the self prefix acquirement method, prefix distribution method and prefix distribution form are determined from the total setting of VPN policy information 203, and processing of acquiring and distributing a prefix is performed. Prefix determination processing where the VPN apparatus 100 of the other party of connection has a function of carrying out negotiation for determination of a prefix is included in the prefix processing unit 212 in this embodiment as in the case of the prefix processing unit of the first embodiment.

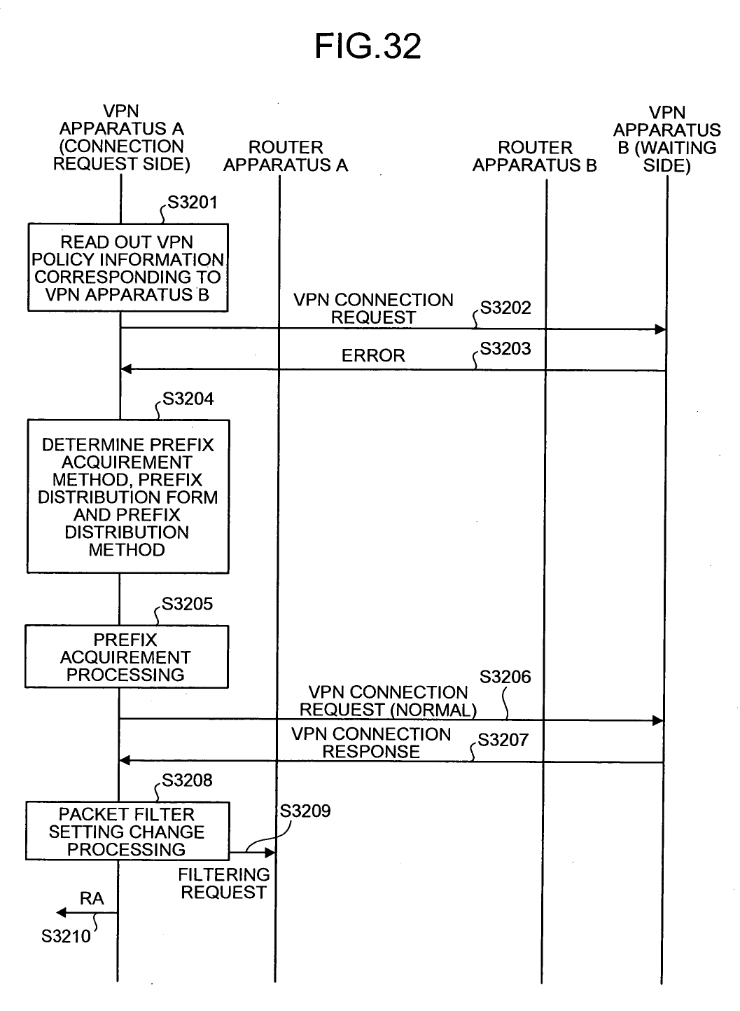

FIG. 32 is a sequence diagram showing an exchange of a message sent and received in prefix determination processing between. VPN apparatuses 100a and 100b having no router function according to the fourth embodiment. Here, the VPN apparatus making a VPN connection request is VPN apparatus A, and the VPN apparatus which is on the side of waiting for the VPN connection request and does not have a function of carrying out negotiation for determination of a prefix is VPN apparatus B. The router apparatus in the network of the VPN apparatus A is router apparatus Am and the router apparatus in the network of the VPN apparatus B is router apparatus B.

The VPN apparatus A on the connection request side reads out VPN policy information 203 corresponding to the VPN apparatus B being the other party of connection (a series of entries identified by the access source address of the VPN apparatus B in the connection setting of VPN policy information 203) by the policy management unit 220 (step S3201). A VPN connection request message including a prefix negotiation message is sent to the VPN apparatus B by the VPN protocol dependent processing unit 211 (step S3202). Because the VPN apparatus B does not have a function of carrying out negotiation for determination of a prefix, the VPN apparatus B cannot interpret the prefix negotiation message even though it receives the VPN connection request message including the prefix negotiation message, and therefore it sends an error to the VPN apparatus A as a response message (step S3203).

In the VPN apparatus A which has received the response message of an error, the self prefix acquirement method, prefix distribution method and prefix distribution form are acquired from the total setting of VPN policy information 203, and the prefix acquirement method, the prefix distribution method and the prefix distribution form are determined according to the contents acquired (step S3204).

Next, in the VPN apparatus A, prefix acquirement processing is performed (step S3205), and a normal VPN connection request message is sent to the VPN apparatus B (step S3206). Here, unlike the VPN connection request message sent at step S3202, the normal VPN connection request message is a message which does not include a prefix negotiation message in accordance with the VPN protocol.

The VPN apparatus B which has received the VPN connection request message performs VPN connection processing in accordance with the VPN protocol, and sends the VPN connection request response message to the VPN apparatus A (step S3207).

In the VPN apparatus A which has received the VPN connection request response message, packet filter setting change processing is performed (step S3208), filtering request information is sent to the router apparatus A (step S3209), an RA is sent back into the network 104 to distribute a VPN prefix (step S3210) in the same manner as in the first embodiment. At step S3403, the VPN apparatus B which does not have a function of carrying out negotiation for determination of a prefix sends an error to the VPN apparatus A when it receives the VPN connection request message including the prefix negotiation message, but it is conceivable that some VPN apparatuses neglect the VPN connection request message including the prefix negotiation message and continue processing without sending back an error. It is conceivable that such a VPN apparatus B sends a normal response message including no prefix negotiation message. Hence, the VPN apparatus A performs processing in step S3404 and subsequent steps as in the case where an error is received as in step S3203 even if the VPN connection request message including the prefix negotiation message is neglected by the VPN apparatus B and the normal response message is sent back from the VPN apparatus B.

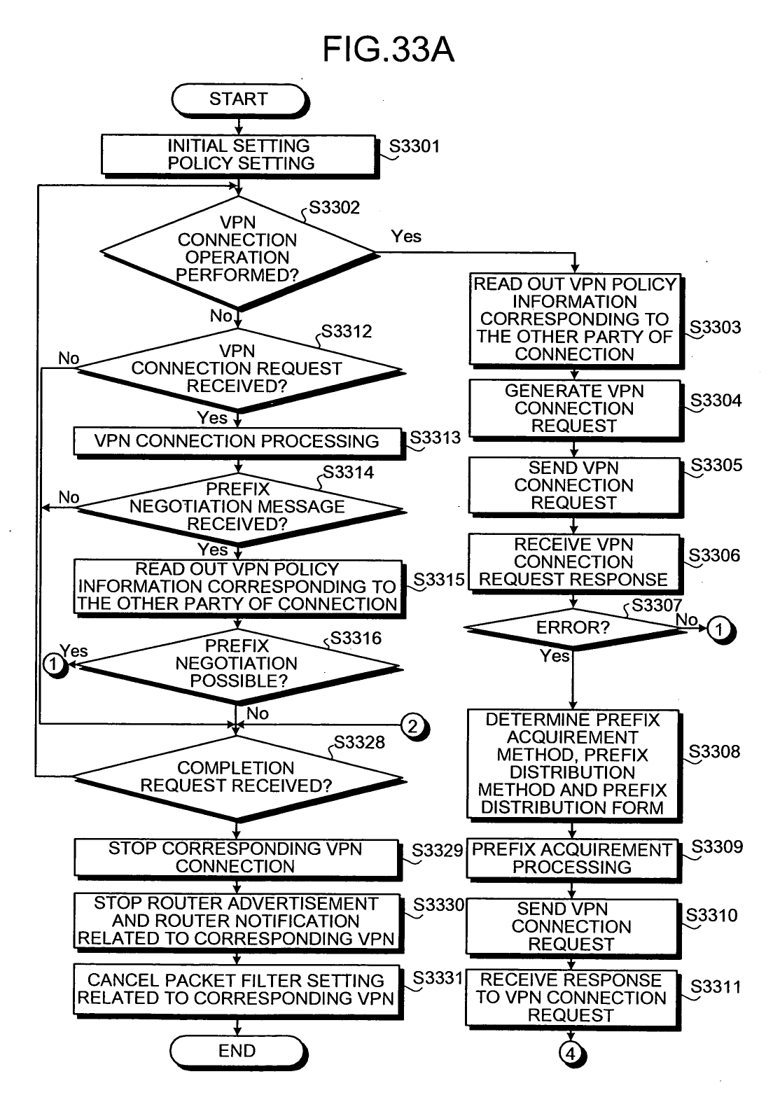

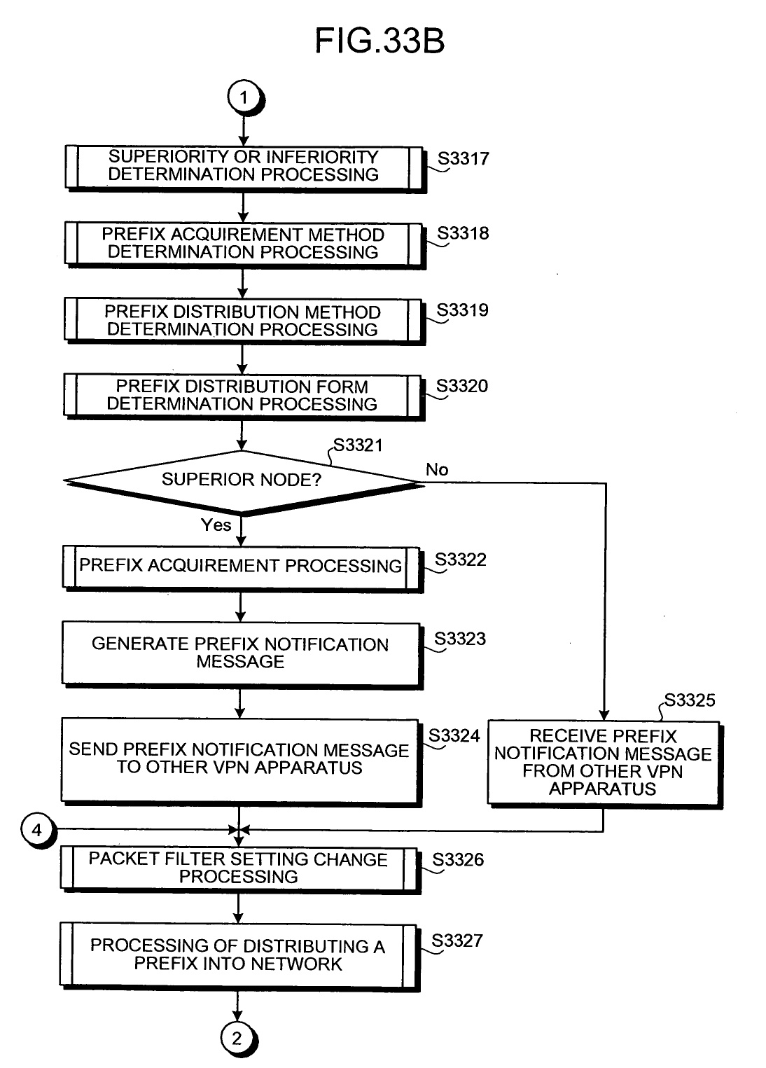

FIGS. 33A and 33B are flowcharts showing a procedure of total processing of determining a prefix by the VPN apparatus 100 according to the fourth embodiment. For the VPN apparatus 100 of this embodiment, processing on the side of waiting for VPN connection is the same as that of the first embodiment, and therefore only processing on the VPN connection request side will be described.

The VPN apparatus 100 makes an initial setting by the VPN protocol dependent processing unit 211 and a policy setting by the policy management unit 220 (step S3301). Whether or not a VPN connection operation has been performed by a user is determined (step S3302), and if the VPN connection operation has been performed (step S3302: Yes), processing on the VPN connection request side in processing of establishing VPN connection is started. Namely, VPN policy information 203 corresponding to the other party of connection (connection setting of the access source address of the other party of connection in VPN policy information 203) is read out by the policy management unit 220 (step S3303). A VPN connection request message including a prefix negotiation message is generated by the prefix processing unit 212 (step S3304), and the VPN connection request message is sent to the VPN apparatus 100 of the other party of connection by the packet sending unit 260 (step S3305).

Thereafter, a VPN connection request response message to the VPN connection request message is received from the VPN apparatus 100 of the other party of connection by the packet receiving unit 250 (step S3306), and then whether or not the VPN connection request response message is an error is checked by the prefix processing unit 212 (step S3307). Since there may be cases where the VPN connection request message including the prefix negotiation message is neglected by the other party of connection, and the VPN connection request response message is a normal response message including no prefix negotiation message as described above, the VPN apparatus 100 of this embodiment determines not only whether or not the VPN connection request response message is an error but also whether or not the VPN connection request response message is a normal response message including no prefix negotiation message.

If the VPN connection request response message is not an error (and it is not a normal response message including no prefix negotiation message) (step S3307: No), processing proceeds to step S3317, where superiority or inferiority determination processing is performed by the prefix processing unit 212 (step S3317). Subsequent prefix acquirement method determination processing, prefix distribution method determination processing, prefix distribution form determination processing, prefix acquirement processing, packet filter setting change processing and processing of distributing a prefix into a network (steps S3318 to S3327) are performed in the same manner as in processing (steps S617 to S626) in FIG. 6B in the VPN apparatus 100 of the first embodiment.

If it is determined at step S3307 that the VPN connection request response message is an error (or it is a normal response message including no prefix negotiation message) (step S3307: Yes), the self prefix acquirement method, prefix distribution method and prefix distribution form are acquired from the total setting of VPN policy information 203 by the policy management unit 220, and the prefix acquirement method, and the prefix distribution method and the prefix distribution form are determined by the prefix processing unit 212 according to the contents acquired (step S3308).

Prefix acquirement processing is performed by the prefix processing unit 212 (step S3309). Detailed processing of prefix acquirement processing is performed in the same manner as in the VPN apparatus 100 of the first embodiment.

Then, a normal VPN connection request message compliant with the VPN protocol, which does not include a prefix message such as a prefix negotiation message, is sent by the VPN protocol dependent processing unit 211 (step S3310), and reception of a response is waited.

A VPN connection request response message to the VPN connection request message is received by the packet receiving unit 250 (step S3311), and then packet filter setting change processing (step S3326) and processing of distributing a prefix in to a network (step S3327) are performed. Thereafter, reception of a completion request is waited, but subsequent processing (steps S3329 to S3331) is performed in the same manner as in the VPN apparatus 100 of the first embodiment. Detailed processing of packet filter setting change processing and processing of distributing a prefix into a network are performed in the same manner as in the VPN apparatus 100 of the first embodiment.

Thus, in the VPN apparatus 100 according to the fourth embodiment, when a VPN connection request message including a prefix negotiation message is sent to the VPN apparatus of the other party of connection and a response of an error is received, the self prefix acquired method, prefix distribution method and prefix distribution form are determined from the total setting of self VPN policy information 203 to perform processing of acquirement and distribution of a prefix, and therefore determination of a prefix is made possible even if the VPN apparatus of the other party of connection does not have a function of carrying out negotiation for determination of a prefix, and the VPN traffic and traffics other than the VPN can be separated based on the VPN prefix between VPN-connected networks.

VPN apparatuses of the first to fourth embodiments are network devices comprising a control apparatus such as a CPU, storage apparatuses such as a ROM (Read Only Memory) and a RAM, and the like as a main hardware structure.

A communication program executed by VPN apparatuses of the first to fourth embodiments is incorporated in a ROM or the like in advance to provide the communication program.

As VPN apparatuses of the first to fourth embodiments, a normal computer comprising a control apparatus such as a CPU, storage apparatuses such as a ROM (Read Only Memory) and a RAM, external storage devices such as a HDD and a CD drive, a display apparatus such as a display device, and input apparatuses such as a keyboard and a mouse as hardware may be used.

In this case, the communication program executed by VPN apparatuses of the first to fourth embodiments may be recorded in a recording medium readable by a computer such as a CD-ROM, flexible disk (FD), CD-R or DVD (Digital Versatile Disk) with a file of an installable format or executable format to provide the communication program.

The communication program executed by VPN apparatuses of the first to fourth embodiments may be stored on a computer connected to a network such as an Internet and downloaded by way of the network, thereby providing the communication program. The communication program executed by VPN apparatuses of the first to fourth embodiments may be provided or distributed by way of a network such as the Internet.

The communication program executed by the VPN apparatuses of the first to fourth embodiments has a module structure including the above-mentioned units (the VPN processing unit 210, the policy management unit 220, the packet forwarding unit 230, the router advertisement processing unit 240, the packet receiving unit 250, the packet sending unit 260, and the PD client unit 1714), and as practical hardware, the CPU (processor) reads a communication program from the above-mentioned storage medium and executes the communication program, whereby the above-mentioned units are loaded onto a main storage apparatus, and the VPN processing unit 210, the policy management unit 220, the packet forwarding unit 230, the router advertisement processing unit 240, the packet receiving unit 250, the packet sending unit 260 and the PD client unit 214, 2714 are generated on the main storage apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a Virtual Private Network protocol dependent processing unit that processes a protocol related to a Virtual Private Network and acquires an identification information message related to determination of Virtual Private Network identification information being network identification information for use in communication by the Virtual Private Network from a message received from a communication apparatus of the other party of connection connected to a network;
an identification information processing unit that determines the Virtual Private Network identification information by sending and receiving the identification information message to and from the communication apparatus of the other party of connection; and
an advertisement processing unit that performs processing related to distribution of the Virtual Private Network identification information determined by the identification information processing unit into the network.

2. The communication apparatus according to claim 1, wherein the identification information processing unit determines the Virtual Private Network identification information by sending and receiving the identification information message to and from the communication apparatus of the other party of connection at the time of processing of establishment of Virtual Private Network connection by the Virtual Private Network protocol dependent processing unit.

3. The communication apparatus according to claim 1, wherein the identification information processing unit further performs superiority or inferiority determination processing of determining whether the self apparatus is a superior node performing processing related to determination of the Virtual Private Network identification information or an inferior node receiving a notification of the Virtual Private Network identification information determined by the superior node by sending a superiority or inferiority determination message based on network information of the self apparatus to the communication apparatus of the other party of connection and by receiving a superiority or inferiority determination message based on network information of the communication apparatus of the other party of connection from the communication apparatus of the other party of connection.

4. The communication apparatus according to claim 1, wherein the identification information processing unit further determines a method for acquiring the network identification information by sending and receiving the identification information message including the method to and from the communication apparatus of the other party of connection.

5. The communication apparatus according to claim 4, further comprising an identification information storage unit that stores all the network identification information managed by the self apparatus, wherein the identification information processing unit determines the Virtual Private Network identification information from the network identification information stored in the identification information storage unit.

6. The communication apparatus according to claim 4, further comprising:
an identification information acquiring unit that sends a request for acquirement of the network identification information to a server managing the network identification information available as the network identification information in the Virtual Private Network provided by an external network, and receives the network identification information from the network of the server as a response to the request; and
an acquired identification information storage unit that stores the network identification information received by the identification information acquiring unit,
wherein the identification information processing unit determines the Virtual Private Network identification information from the network identification information stored in the acquired identification information storage unit.

7. The communication apparatus according to claim 6, wherein the server is a Prefix Delegation server which generates the network identification information.

8. The communication apparatus according to claim 4, further comprising:
an identification information acquiring unit that sends a request for acquirement of the network identification information to a server managing the network identification information available as the network identification information in the Virtual Private Network provided by an external network, and receives the network identification information from the server as a response to the request,
wherein the identification information processing unit commands the identification information acquiring unit to send the request to the server, and determines the Virtual Private Network identification information from the network identification information received by the identification information acquiring unit.

9. The communication apparatus according to claim 4, further comprising an identification information storage unit that stores all the network identification information managed by the self apparatus,
wherein the identification information processing unit generates the network identification information in accordance with a rule predefined in the IPv6 protocol, and determines network identification information with the generated network identification information not overlapping the network identification information stored in the identification information storage unit as the Virtual Private Network identification information.

10. The communication apparatus according to claim 4, further comprising an identification information storage unit that stores all the network identification information managed by the self apparatus,
wherein the identification information processing unit generates the network identification information at random, and determines network identification information with the generated network identification information not overlapping the network identification information stored in the identification information storage unit as the Virtual Private Network identification information.

11. The communication apparatus according to claim 1, wherein the identification information processing unit further determines a method for distributing the Virtual Private Network identification information by sending and receiving the identification information message including the method to and from the communication apparatus of the other party of connection.

12. The communication apparatus according to claim 11, wherein the advertisement processing unit distributes the Virtual Private Network identification information into the network with a router advertisement.

13. The communication apparatus according to claim 12, wherein the advertisement processing unit requests a router apparatus connected to the network to distribute the Virtual Private Network identification information with the router advertisement.

14. The communication apparatus according to claim 1, wherein the identification information processing unit further determines a form of distribution of the Virtual Private Network identification information by sending and receiving the identification information message including the distribution form between to and from the communication apparatus of the other party of connection.

15. The communication apparatus according to claim 14, wherein the advertisement processing unit distributes the Virtual Private Network identification information into all VPN-connected networks when the distribution form is determined to be collective distribution by the identification information processing unit.

16. The communication apparatus according to claim 1, further comprising a packet filter unit that changes a packet filter setting in communication by the Virtual Private Network based on the Virtual Private Network identification information determined by the identification information processing unit.

17. The communication apparatus according to claim 16, wherein the packet filter unit changes the packet filter setting in communication by the Virtual Private Network to a setting of a value in which none of messages for distributing the network identification information for all network identification information which are sent and received in communication by the Virtual Private Network pass through the Virtual Private Network.

18. The communication apparatus according to claim 17, wherein the packet filter unit changes the packet filter setting in communication by the Virtual Private Network protocol to a setting of a value in which none of traffics for all network identification information except for the Virtual Private Network identification information determined by the identification information processing unit pass through the Virtual Private Network.

19. The communication apparatus according to claim 1, wherein the identification information processing unit further performs superiority or inferiority determination processing of determining whether the self apparatus is a superior node performing processing related to determination of the Virtual Private Network identification information or an inferior node receiving a notification of the Virtual Private Network identification information determined by the superior node from network information of the self apparatus and previously acquired network information of the communication apparatus of the other party of connection.

20. The communication apparatus according to claim 1, wherein the identification information processing unit determines the Virtual Private Network identification information without sending and receiving the identification information message to and from the communication apparatus of the other party of connection when receiving an error as a response to a Virtual Private Network connection request including the identification information message to the communication apparatus of the other party of connection.

21. A router apparatus, distributing network identification information into a network with a router advertisement when receiving a request for distribution of Virtual Private Network identification information being the network identification information for use in communication by a Virtual Private Network from a communication apparatus connected to a network.

22. A communication method comprising:
acquiring an identification information message related to determination of Virtual Private Network identification information being network identification information for use in communication by a Virtual Private Network from a message received from a communication apparatus of the other party of connection connected to a network while processing a protocol related to the Virtual Private Network;
determining the Virtual Private Network identification information by sending and receiving the identification information message to and from the communication apparatus of the other party of connection; and
performing processing related to distribution of the Virtual Private Network identification information determined by the identification information processing unit into the network.

23. A communication method comprising:
receiving a request for distribution of Virtual Private Network identification information being the network identification information for use in communication, by a Virtual Private Network from a communication apparatus connected to a network; and
distributing network identification information into a network with a router advertisement.

24. A computer program product having a computer readable medium including programmed instructions for performing a communication processing, wherein the instructions, when executed by a computer, cause the computer to perform:
acquiring an identification information message related to determination of Virtual Private Network identification information being network identification information for use in communication by a Virtual Private Network from a message received from a communication apparatus of the other party of connection connected to a network while processing a protocol related to the Virtual Private Network;
determining the Virtual Private Network identification information by sending and receiving the identification information message to and from the communication apparatus of the other party of connection; and
performing processing related to distribution of the Virtual Private Network identification information determined by the identification information processing unit into the network.

25. A computer program product having a computer readable medium including programmed instructions for performing a communication processing, wherein the instructions, when executed by a computer, cause the computer to perform:
receiving a request for distribution of Virtual Private Network identification information being the network identification information for use in communication by a Virtual Private Network from a communication apparatus connected to a network; and
distributing network identification information into a network with a router advertisement.
